(19) United States
(12) Patent Application Publication
(10) Pub. No.: US 2021/0051586 A1
(43) Pub. Date: Feb. 18, 2021

(54) ACCESS POINT APPARATUS, STATION APPARATUS, AND COMMUNICATION METHOD

(71) Applicants: SHARP KABUSHIKI KAISHA, Sakai City, Osaka (JP); FG INNOVATION COMPANY LIMITED, Tuen Mun, New Territories (HK)

(72) Inventors: HIDEO NAMBA, Sakai City, Osaka (JP); HIROMICHI TOMEBA, Sakai City, Osaka (JP)

(21) Appl. No.: 16/641,065

(22) PCT Filed: Jul. 20, 2018
(86) PCT No.: PCT/JP2018/027203

§ 371 Date: Feb. 21, 2020

(30) Foreign Application Priority Data
Sep. 1, 2017 (JP) 2017-168342

(51) Int. Cl. H04W 52/02; H04W 80/02; H04L 1/00

(52) U.S. Cl. CPC H04W 52/0229; H04W 84/12; H04L 1/0003; H04W 80/02

(57) ABSTRACT

Immediately after signaling to transition to a standby state between the access point apparatus and the station apparatus of the present invention, the access point apparatus transmits a wake-up radio signal and transitions to a standby state after acknowledgement of the delivery of the wake-up radio signal.

### TECHNICAL FIELD

The present invention relates to an access point apparatus, a station apparatus, and a communication method.

This application claims priority based on JP 2017-168342 filed on Sep. 1, 2017, the contents of which are incorporated herein by reference.

### BACKGROUND ART

In recent years, use of a radio communication system that includes at least a self-supporting terminal apparatus or a base station apparatus that can be relatively freely used has been advanced, and such a system is used in various applications in various forms including wireless LAN. In particular, wireless LAN can easily be introduced, and is applicable to a form of network that enables connection to the Internet, and a form of network that is isolated from the outside, and is used for wide applications. The communication speed of wireless LAN was approximately 1 Mbps at the beginning. The speed has progressed with advance in technology, and the total throughput of communication data in a base station apparatus exceeds 1 Gbps (NPL 1).

On the other hand, unlike wireless LAN, the use of radio communication systems that primarily focus on reducing the power consumption of a terminal apparatus rather than speeding up of the communication speed has also advanced. Examples of such radio communication systems include Bluetooth (trade name), ZIGBEE (trade name), and the like, and are used mainly in systems that use a battery as the power source.

As the spread of wireless LAN, there is an increased demand to introduce wireless LAN into a device that uses a battery as the power source. While current wireless LAN defines a power-saving operation that increases standby time, this needs to increase standby time to reduce power consumption, which means increase in waiting time until communication is enabled in a case that communication data occurs, i.e., increased latency, causing a significant decrease in user experience.

Thus, recently, standardization of communication systems is conducted that attempt low power consumption and shortening in standby time, by adding a wireless function operating at low power to a physical layer of the wireless LAN and using this added wireless function at standby time (NPL 2).

### CITATION LIST

### Non Patent Literature

NPL 1: IEEE std 802.11-2016

NPL 2: IEEE P802.11, A PAR Proposal for Wake-up radio

### SUMMARY OF INVENTION

### Technical Problem

For standardization of new communication systems, coexistence with existing standards is an important challenge. However, it has been studied that signal frames handled in an added wireless function are used with signal waveforms that are different from the signal frames handled in existing wireless LAN. As a result, a communication distance by the existing wireless LAN signal and a communication distance by the added wireless function may be different from each other, and problems may arise in a case that a wireless LAN terminal apparatus located near the communication distance limit returns from the standby state. In particular, in a case that the communication distance by the added wireless function is shorter than the communication distance by the existing wireless LAN signal, the wireless LAN terminal apparatus that has transitioned to the standby state may not receive a signal of the added wireless function, and may not return in a case that communication is required.

One aspect of the present invention has been made in view of the above problems, and an object of the present invention is to disclose an access point apparatus, a station apparatus, and a communication method that prevent a failure of recovery from a standby state due to non-delivery of a signal frame of a different standard.

### Solution to Problem

(1) In order to achieve the above object, in accordance with one aspect of the present invention, provided is an access point apparatus for connecting and wirelessly communicating with multiple station apparatuses including a first station apparatus, the access point apparatus including: a transmission RF unit configured to transmit a wireless LAN signal and a wake-up radio signal; a reception RF unit configured to receive a carrier sense and the wireless LAN signal; and a controller configured to control a transmission signal and a reception signal. The controller performs signaling for a WUR transition with the first station apparatus by using the wireless LAN signal, performs the carrier sense by using the reception RF unit in a WUR transition state after the signaling, and transmits the wake-up radio signal by using the transmission RF unit after the carrier sense to cause the first station apparatus to transition to a WU radio standby state that uses the wake-up radio.

(2) In accordance with another aspect of the present invention, provided is an access point apparatus, where the controller is configured to perform, after transmitting the wake-up radio signal, reception of a wake-up radio recovery request packet using the wireless LAN signal by using the reception RF unit, and retransmission of the wake-up radio signal after receiving the wake-up radio recovery request packet.

(3) In accordance with another aspect of the present invention, provided is an access point apparatus, where the controller is configured to reconfigure an MCS of the wake-up radio during the retransmission.

(4) In accordance with another aspect of the present invention, provided is an access point apparatus, where the wake-up radio signal transmitted in the WUR transition state is different from the wake-up radio signal used in a case that the first station apparatus is in the WU radio standby state.

(5) In accordance with another aspect of the present invention, provided is an access point apparatus, where a length of a radio frame of the wake-up radio signal transmitted in the WUR transition state is shorter than a length of a radio frame of the wake-up radio signal used in a case that the first station apparatus is in the WU radio standby state.

(6) In accordance with another aspect of the present invention, provided is a station apparatus for connecting and wirelessly communicating with an access point apparatus, the station apparatus including: a transmission RF unit configured to transmit a wireless LAN signal; a reception RF unit configured to receive a carrier sense, the wireless LAN signal, and a wake-up radio signal; and a controller configured to control a transmission signal and a reception signal. The controller is configured to perform signaling for a WUR transition with the access point apparatus by using the wireless LAN signal, receive the wake-up radio signal by using the reception RF unit in a WUR transition state after the signaling, and cause the station apparatus to transition to a WU radio standby state that uses the wake-up radio signal after receiving the wake-up radio signal.

(7) In accordance with another aspect of the present invention, provided is a station apparatus, where in a case that the wake-up radio signal is not received within a prescribed time in the WUR transition state, the controller transmits a wake-up radio recovery request packet that uses the wireless LAN signal by using the transmission RF unit.

(8) In accordance with another aspect of the present invention, provided is a station apparatus, where after transmitting the wake-up radio recovery request packet and receiving an acknowledgement response to the wake-up radio recovery request packet that uses wireless LAN signal, the controller causes the station apparatus to transition to a WU radio standby state that uses the wake-up radio signal in a case that the wake-up radio signal is received by using the reception RF unit.

(9) In accordance with another aspect of the present invention, provided is a communication method of an access point apparatus for connecting and wirelessly communicating with multiple station apparatuses including a first station apparatus, the communication method including the steps of: transmitting a wireless LAN signal; transmitting a wake-up radio signal; performing a carrier sense; and receiving the wireless LAN signal, wherein signaling for a WUR transition is performed with the first station apparatus by using the wireless LAN signal, the carrier sense is performed in a WUR transition state after the signaling, and the wake-up radio signal is transmitted after the carrier sense to cause the first station apparatus to transition to a WU radio standby state that uses the wake-up radio.

(10) In accordance with another aspect of the present invention, provided is a communication method of a station apparatus for connecting and wirelessly communicating with an access point apparatus, the communication method including the steps of: transmitting a wireless LAN signal; performing a carrier sense; receiving the wireless LAN signal; and receiving a wake-up radio signal, wherein signaling for a WUR transition is performed with the access point apparatus by using the wireless LAN signal, the wake-up radio signal is received in a WUR transition state after the signaling, and the station apparatus is caused to transition to a WU radio standby state that uses the wake-up radio signal after the wake-up radio signal is received.

### Advantageous Effects of Invention

One aspect of the invention can contribute to improved utilization of wireless LAN devices, as an access point apparatus, a station apparatus, and a communication method are provided that significantly reduce the likelihood that the station apparatus standard will fail to return from a standby state due to failure to receive a wake-up radio signal.

### BRIEF DESCRIPTION OF DRAWINGS

FIG. 1 is a diagram illustrating an example of a device configuration according to an embodiment of the present invention.

FIG. 2 is a diagram illustrating a PPDU configuration of the IEEE802.11ac standard.

FIG. 3 is a diagram illustrating an example of an L-SIG Duration.

FIG. 4 is a diagram illustrating an example of frequency resource division according to an embodiment of the present invention.

FIG. 5 is a diagram illustrating an example of a configuration of a PPDU according to an embodiment of the present invention.

FIG. 6 is a diagram illustrating an example of frame transmission according to an embodiment of the present invention.

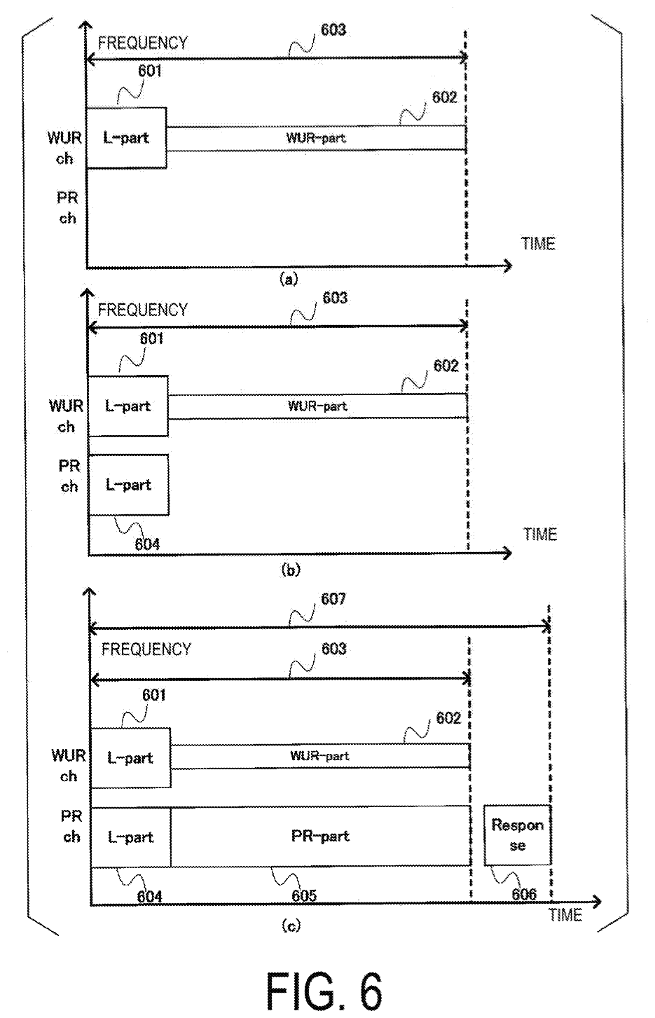

FIG. 7 is a diagram illustrating an example of a configuration of a WU radio frame according to an embodiment of the present invention.

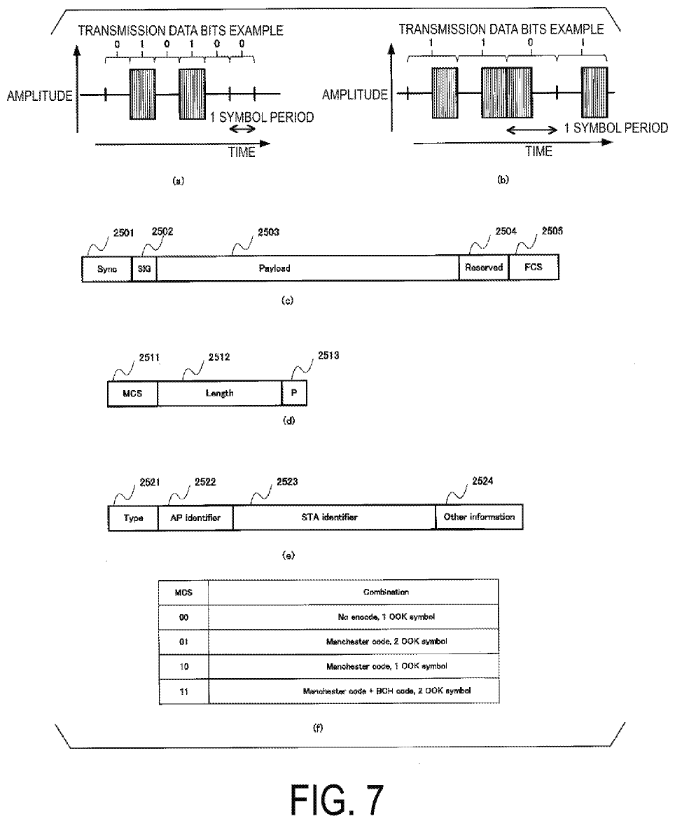

FIG. 8 is a diagram illustrating an example of channel access according to an embodiment of the present invention.

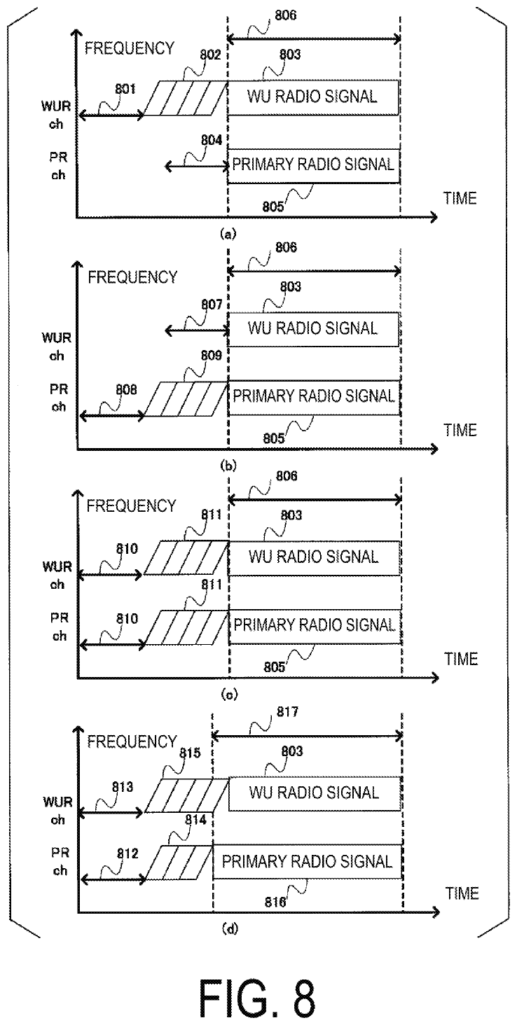

FIG. 9 is a diagram illustrating message flow according to an embodiment of the present invention.

FIG. 10 is a diagram illustrating message flow according to an embodiment of the present invention.

FIG. 11 is a diagram illustrating a sequence chart illustrating an operation overview according to an embodiment of the present invention.

FIG. 12 is a block diagram illustrating an example of a configuration of a station used in an embodiment of the present invention.

FIG. 13 is a block diagram illustrating an example of a configuration of a station used in an embodiment of the present invention.

FIG. 14 is a diagram illustrating an example of a configuration of a WU radio signal used in an embodiment of the present invention.

FIG. 15 is a diagram illustrating an example of a configuration of a WU radio signal used in an embodiment of the present invention.

FIG. 16 is a flowchart illustrating processing of a station used in an embodiment of the present invention.

FIG. 17 is a flowchart illustrating processing of a station used in an embodiment of the present invention.

FIG. 18 is a flowchart illustrating processing of an access point used in an embodiment of the present invention.

FIG. 19 is a flowchart illustrating processing of an access point used in an embodiment of the present invention.

FIG. 20 is a diagram illustrating an example of a configuration of a WU radio frame used in an embodiment of the present invention.

### DESCRIPTION OF EMBODIMENTS

Hereinafter, a radio communication technology according to an embodiment of the present invention will be described in detail with reference to the drawings.

A communication system according to the present embodiment includes a radio transmission apparatus (Access point, base station apparatus, access point apparatus), and multiple radio reception apparatuses (stations, terminal apparatuses, station apparatuses). A network constituted by a base station apparatus and a terminal apparatus is referred to as a Basic service set (BSS, management range). The base station apparatus and the terminal apparatus are collectively referred to as a radio apparatus. The terminal apparatus can include a function included in a base station apparatus.

Each of the base station apparatus and the terminal apparatus in the BSS perform communication, based on Carrier sense multiple access with collision avoidance (CSMA/CA). The present embodiment is directed to an infrastructure mode in which the base station apparatus performs communication with multiple terminal apparatuses, but a method of the present embodiment can be implemented in an ad hoc mode in which the terminal apparatuses perform communication directly with each other. In an ad hoc mode, a terminal apparatus replaces a base station apparatus and forms a BSS. A BSS in an ad hoc mode is also referred to as an Independent Basic Service Set (IBSS). In the following, each terminal apparatus forming an IBSS in an ad hoc mode may be considered as a base station apparatus.

In an IEEE802.11 system, each apparatus is capable of transmitting multiple frame types of transmission frames with a common frame format. The transmission frames are defined by a Physical (PHY) layer, a Medium access control (MAC) layer, a Logical Link Control (LLC) layer.

The PHY layer transmission frame is referred to as a physical protocol data unit (PHY protocol data unit (PPDU), physical layer frame). The PPDU includes a physical layer header (PHY header) including header information for performing signal processing in the physical layer and the like and a physical service data unit (PHY service data unit (PSDU)), which is a data unit processed in the physical layer, and the like. The PSDU can include an Aggregated MPDU (A-MPDU) where multiple MAC protocol data units (MPDUs) serving as retransmission units in the radio section are aggregated.

The PHY header includes reference signals such as a Short training field (STF) used for signal detection, synchronization, and the like, a Long training field (LTF) used for acquiring channel information for data demodulation, and control signals such as Signals (SIG) that contain control information for data demodulation. The STF is classified into, depending on the corresponding standard, a Legacy-STF (L-STF), a High throughput-STF (HT-STF), a Very high throughput-STF (VHT-STF), and a High efficiency-STF (HE-STF), and the like, and LTF and SIG are similarly classified into L-LTF, HT-LTF, VHT-LTF, HE-LTF, L-SIG, HT-SIG, VHT-SIG, HE-SIG. The VHT-SIG is further classified into VHT-SIG-A1, VHT-SIG-A2 and VHT-SIG-B. Similarly, the HE-SIG is classified into HE-SIG-A1 to 4 and HE-SIG-B.

Furthermore, the PHY header may include information for identifying the BSS of the transmission source of the transmission frame (hereinafter, also referred to as BSS identification information). The information for identifying the BSS may be, for example, a Service Set Identifier (SSID) of the BSS or a MAC address of a base station apparatus of the BSS. The information for identifying the BSS may be a BSS-specific value (for example, BSS Color, and the like) other than an SSID and a MAC address.

The PPDU is modulated according to a supporting standard. For example, in the IEEE802.11n standard, the PPDU may be modulated to an Orthogonal frequency division multiplexing (OFDM) signal. For example, in the IEEE802.11ad standard, the PPDU may be modulated to a single carrier signal.

The MPDU includes a MAC layer header (MAC header) including header information and the like for performing signal processing in the MAC layer, a MAC service data unit (MSDU) or a frame body, which is a date unit processed in the MAC layer, and a frame check unit (Frame check sequence (FCS)) for checking whether or not there is no error in the frame. It is also possible that multiple MSDUs are aggregated as an Aggregated MSDU (A-MSDU).

The frame types of transmission frames of the MAC layer are roughly classified into three, management frames that manage connection states and the like between apparatuses, control frames that manage communication states between apparatuses, and data frames that include actual transmission data, each of which is further classified into multiple types of subframe types. The control frames include a reception completion notification (Acknowledge (Ack)) frame, a transmission request (Request to send (RTS)) frame, a reception preparation completion (Clear to send (CTS)) frame, and the like. The management frames include a Beacon frame, a Probe request frame, a Probe response frame, an Authentication frame, a connection request (Association request) frame, a connection response (Association response) frame, and the like. The data frames include a Data frame, a polling (CF-poll) frame, and the like. By reading the contents of the frame control field included in the MAC header, each apparatus can grasp the frame type and the subframe type of the received frame.

Note that the Ack may include a Block Ack. The Block Ack is capable of performing a reception completion notification for multiple MPDUs.

The beacon frame includes a Field that describes a period (Beacon interval) in which a beacon is transmitted and an SSID. The base station apparatus is capable of periodically broadcasting a beacon frame in the BSS, and the terminal apparatus is capable of receiving a beacon frame to grasp the base station apparatus around the terminal apparatus. Grasping the base station apparatus by the terminal apparatus, based on the beacon frame broadcast by the base station apparatus is referred to as Passive scanning. On the other hand, probing the base station apparatus by the terminal apparatus broadcasting the probe request frame in the BSS is referred to as Active scanning. The base station apparatus is capable of transmitting a probe response frame as a response to the probe request frame, and the description of the probe response frame is equivalent to the beacon frame.

After the terminal apparatus recognizes the base station apparatus, the terminal apparatus performs connection processing on the base station apparatus. The connection processing is classified as an Authentication procedure and a connection (Association) procedure. The terminal apparatus transmits an authentication frame (authentication request) to a base station apparatus with which the terminal apparatus wants to be connected. In a case of receiving the authentication frame, the base station apparatus transmits, to the terminal apparatus, an authentication frame (authentication response) including a status code indicating whether authentication is available or not for the terminal apparatus. The terminal apparatus can determine whether or not the terminal apparatus is allowed with authentication by the base station apparatus by reading the status code described in the authentication frame. Note that the base station apparatus and the terminal apparatus are capable of exchanging authentication frames multiple times.

Following the authentication procedure, the terminal apparatus transmits a connection request frame in order to perform a connection procedure to the base station apparatus. In a case of receiving the connection request frame, the base station apparatus determines whether or not to allow connection of the terminal apparatus and transmits a connection response frame in order to notify the determination result. In addition to the status code indicating whether a connection process is available, an association identification number (Association identifier (AID)) for identifying a terminal apparatus is described in the connection response frame. The base station apparatus can manage multiple terminal apparatuses by configuring different AID for each terminal apparatus that has been allowed to connect.

After the connection processing is performed, the base station apparatus and the terminal apparatus perform actual data transmission. In the IEEE802.11 system, a distributed control mechanism (Distributed Coordination Function (DCF)) a centralized control mechanism (Point Coordination Function (PCF)), an expanded mechanism of these (Enhanced distributed channel access (EDCA)), and a hybrid control mechanism (Hybrid coordination function (HCF), and the like) are defined. Hereinafter, a case in which the base station apparatus transmits a signal to the terminal apparatus by the DCF is described as an example.

In the DCF, prior to communication, the base station apparatus and the terminal apparatus perform Carrier sense (CS) to confirm a usage status of radio channels around the apparatus itself. For example, in a case that the base station apparatus that is a transmitting station receives a signal on the radio channel higher than a predetermined Clear channel assessment level (CCA level), the base station apparatus postpones transmission of a transmission frame on the radio channel. Hereinafter, a state in which a signal at or above the CCA level is detected in the radio channel is referred to as a Busy state, and a state in which no signal at or above the CCA level is detected is referred to as an Idle state. In this manner, CS performed based on the power (received power level) of the signal actually received by each apparatus is referred to as physical carrier sense (physical CS). Note that the CCA level is also referred to as a carrier sense level (CS level) or CCA threshold (CCAT). Note that, in a case that the base station apparatus and the terminal apparatus detect a signal at or above the CCA level, the base station apparatus and the terminal apparatus enter an operation of demodulating at least a signal of the PHY layer. Thus, the carrier sense level may be a minimum received power (minimum reception sensitivity) at which the base station apparatus and the terminal apparatus can successfully demodulate the received frame.

The base station apparatus performs carrier sense by a frame interval (Inter frame space (IFS)) depending on the type on the transmission frame to be transmitted, and determines whether the radio channel is in the busy state or the idle state. The period during which the base station apparatus performs carrier sense depends on the frame type and the subframe type of the transmission frame to be transmitted by the base station apparatus. The IEEE802.11 system defines multiple IFSs with different periods, including a short frame interval (Short IFS (SIFS)) used for a transmission frame with the highest priority given, a polling frame interval (PCF IFS (PIFS)) used for a transmission frame with a relatively high priority, and a distributed control frame interval (DCF IFS (DIFS)) used for a transmission frame with the lowest priority, and an IFS used for a transmission frame with higher priority has a shorter period. In a case that the base station apparatus transmits a data frame by the DCF, the base station apparatus uses the DIFS. Note that, in the EDCA, an arbitration frame interval (Arbitration IFS (AIFS)) is available, and in the AIFS, different periods can be for each Access category (AC) configured for a frame to be transmitted by the base station apparatus, and the frame priority can be further flexibly configured.

After waiting by the DIFS, the base station apparatus waits further for a random back-off time to prevent frame collisions. In the IEEE802.11 system, a random back-off time, referred to as a Contention window (CW), is used. In the CSMA/CA, it is assumed that the transmission frame transmitted by one transmitting station is received by a receiving station in a state where there is no interference from other transmitting stations. Therefore, in a case that transmission frames are transmitted at the same timing by transmitting stations, the frames collide with each other, and the receiving station cannot successfully receive the frames. Thus, the frame collision is avoided by each of the transmitting stations waiting for a time randomly configured before starting transmission. In a case that the base station apparatus determines that the radio channel is in the idle state by the carrier sense, the base station apparatus starts countdown of the CW, acquires the transmission right for the first time in a case that the CW is 0, and transmits the transmission frame to the terminal apparatus. Note that, in a case that the base station apparatus determines that the radio channel is in the busy state by the carrier sense during the countdown of CW, the countdown of the CW is stopped. Then, in a case that the radio channel is in the idle state, following the previous IFS, the base station apparatus resumes the countdown of the CW remaining.

The terminal apparatus, which is a receiving station, receives the transmission frame, reads the PHY header of the transmission frame, and demodulates the transmission frame received. Then, the terminal apparatus can recognize whether the transmission frame is addressed to the terminal apparatus, by reading the MAC header of the demodulated signal. Note that the terminal apparatus can determine the destination of the transmission frame, based on information described in the PHY header (for example, VHT-SIG-A described group identification number (Group identifier (GID), Group ID)).

In a case that the terminal apparatus determines that the received transmission frame is addressed to the terminal apparatus, and the transmission frame can be demodulated without errors, the terminal apparatus must transmit an ACK frame indicating that the frame has been received successfully to the base station apparatus, which is the transmitting station. The ACK frame is one of the highest priority transmission frames transmitted on only the SIFS period of standby (random back-off time is not taken). The base station apparatus terminates the set of communications in a case of receiving the ACK frame transmitted from the terminal apparatus. Note that in a case that the terminal apparatus cannot successfully receive the frame, the terminal apparatus does not transmit the ACK. Thus, in a case that the base station apparatus does not receive an ACK frame from the receiving station for a certain period (SIFS +ACK frame length) after transmitting the frame, the communication ends as the communication failed. In this manner, the termination of one communication (also referred to as a burst) of the IEEE802.11 system is always determined by the presence or absence of reception of an ACK frame, except in a case of transmission of a broadcast signal such as a beacon frame or in a special case such as a case that fragmentation is used to divide the transmission data.

In a case that the terminal apparatus determines that the received transmission frame is not addressed to the terminal apparatus, the terminal apparatus configures the Network allocation vector (NAV), based on the Length of the transmission frame described in the PHY header or the like. The terminal apparatus does not attempt communication for a period configured for the NAV. In other words, since the terminal apparatus performs the same operation as a case that the physical CS determines that the radio channel is in the busy state, for the period configured for the NAV, the communication control by the NAV is also referred to as virtual carrier sense (virtual CS). In addition to being configured based on the information described in the PHY header, the NAV is also configured by a transmission request (Request to send (RTS)) frame or a reception preparation completion (Clear to send (CTS)) frame introduced to resolve a hidden terminal problem.

Compared with the DCF where each apparatus performs carrier sense and autonomously acquires transmission rights, in the PCF, a control station called a Point coordinator (PC) controls the transmission rights of each apparatus in the BSS. In general, a base station apparatus is the PC and acquires the transmission right for a terminal apparatus in a BSS.

The communication period by the PCF includes a non-contention period (Contention free period (CFP)) and a Contention period (CP). During the CP, communication is performed based on the DCF previously described, and the PC controls transmission rights during the CFP. The base station apparatus which is the PC broadcasts a beacon frame where a CFP period (CFP Max duration) and the like is described in the BSS prior to the PCF communication. Note that the PIFS is used for the transmission of a beacon frame broadcast at the start of transmission of the PCF and transmitted without waiting for the CW. The terminal apparatus that has received the beacon frame configures a period of the CFP described in the beacon frame to the NAV. Thereafter, the terminal apparatus can acquire the transmission right only in a case that a signal (for example, a data frame including CF-poll) is received that signals acquisition of the transmission right transmitted by the PC, until the NAV has elapsed or a signal for broadcasting the end of the CFP in the BSS (for example, a data frame including CF-end) is received. Note that, in the CFP period, there is no collision of packets within the same BSS, so that each terminal apparatus does not take the random back-off time used for the DCF.

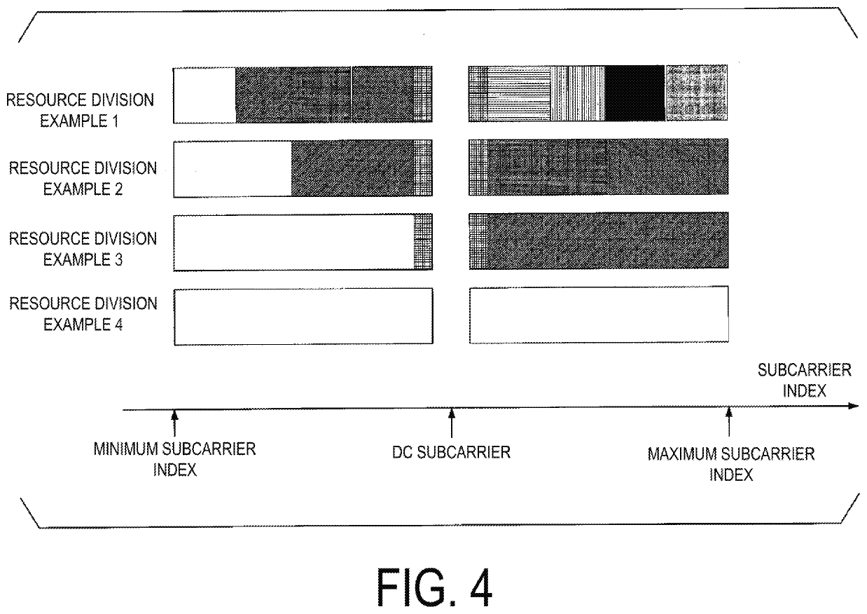

A radio medium may be divided into multiple Resource units (RUs). FIG. 4 is a schematic diagram illustrating an example of a division state of a radio medium. For example, in the resource division example 1, the radio communication apparatus can divide a frequency resource (subcarrier) serving as a radio medium into nine RUs. Similarly, in the resource division example 2, the radio communication apparatus can divide a subcarrier serving as a radio medium into five RUs. Of course, the resource division examples illustrated in FIG. 4 are merely examples, and for example, each of multiple RUs may be constituted by different number of subcarriers. The radio medium divided as a RU can include not only a frequency resource but also a spatial resource. The radio communication apparatus (for example, AP) may transmit frames to multiple terminal apparatuses (for example, multiple STAs) at the same time by disposing frames addressed to different terminal apparatuses on each RU. The AP may describe information (Resource allocation information) indicating the state of the division of the radio medium as common control information in the PHY header of the frame transmitted by the apparatus itself. Furthermore, the AP may describe information (resource unit assignment information) indicating RUs where frames addressed to each STA are allocated as unique control information in the PHY header of the frame transmitted by the apparatus itself.

Multiple terminal apparatuses (for example, multiple STAs) can transmit frames at the same time, by arranging and transmitting frames on the assigned RUs. After receiving a frame (Trigger frame (TF)) including trigger information transmitted from the AP, the multiple STAs can perform frame transmission after waiting for a prescribed period. Each STA can grasp RUs assigned to the apparatus itself, based on the information described in the TF. Each STA can acquire RUs by random access based on the TF.

The AP can simultaneously assign multiple RUs to one STA. The multiple RUs may be constituted by continuous subcarriers or may be constituted by discontinuous subcarriers. The AP may transmit one frame by using multiple RUs assigned to one STA, or may allocate multiple frames to different RUs to transmit. At least one of the multiple frames may be a frame including common control information for multiple terminal apparatuses that transmit Resource allocation information.

One STA may be assigned multiple RUs by the AP. The STA may transmit one frame by using the multiple assigned RUs. The STA may use the multiple assigned RUs to assign multiple frames to different RUs to transmit. The multiple frames can be frames of different frame types.

The AP may assign multiple Associate IDs (AIDs) to one STA. The AP can assign RUs to multiple AIDs assigned to one STA. The AP can transmit different frames by using the RUs assigned for the multiple AIDs assigned to one STA. The different frames can be frames of different frame types.

One STA may be assigned multiple Associate IDs (AIDs) by the AP. One STA may be assigned with RUs for the multiple assigned AIDs. One STA may recognize each RU assigned to the multiple AIDs assigned to the apparatus itself as RU assigned to the apparatus itself and can transmit one frame by using the assigned multiple RUs. One STA may transmit multiple frames by using the multiple assigned RUs. At this time, information indicating the AIDs associated with the assigned RUs can be described in the multiple frames and transmitted. The AP can transmit different frames by using the RUs assigned for the multiple AIDs assigned to one STA. The different frames can be frames of different frame types.

Hereinafter, the base station apparatus and the terminal apparatus are collectively referred to as radio communication apparatuses. Information exchanged in a case that a radio communication apparatus communicates with another radio communication apparatus is also referred to as data. In other words, the radio communication apparatus includes a base station apparatus and a terminal apparatus.

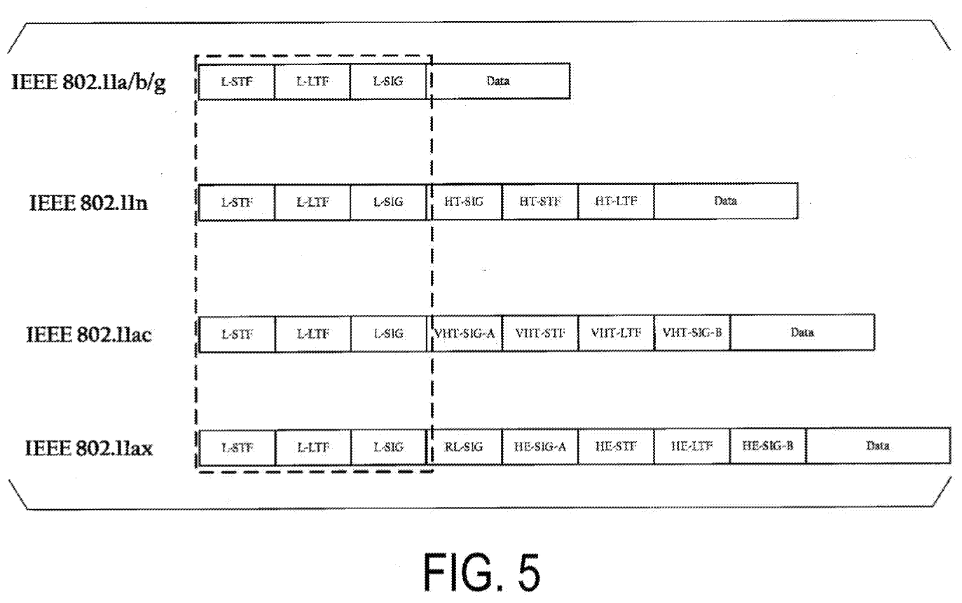

The radio communication apparatus includes either or both of a function of transmitting and a function of receiving a PPDU. FIG. 5 is a diagram illustrating an example of a configuration of a PPDU transmitted by the radio communication apparatus. A PPDU corresponding to the IEEE802.11a/b/g standard has a configuration that includes an L-STF, an L-LTF, an L-SIG, and a Data frame (MAC Frame, MAC frame, payload, data part, data, information bits, etc.). A PPDU corresponding to the IEEE802.11n standard has a configuration that includes an L-STF, an L-LTF, an L-SIG, an HT-SIG, an HT-STF, an HT-LTF, and a Data frame. A PPDU corresponding to the IEEE802.11ac standard has a configuration that includes some or all of an L-STF, an L-LTF, an L-SIG, a VHT-SIG-A, a VHT-STF, a VHT-LTF, a VHT-SIG-B, and a MAC frame. A PPDU studied in the IEEE802.11ax standard has a configuration that includes some or all of an RL-SIG, an HE-SIG-A, an HE-STF, an HE-LTF, an HE-SIG-B and a Data frame where an L-STF, an L-LTF, an L-SIG, and an L-SIG are temporally repeated.

A L-STF, an L-LTF, and an L-SIG, which are surrounded by dotted lines in FIG. 5, are a configuration commonly used in IEEE802.11 standards (hereinafter, an L-STF, an L-LTF, and an L-SIG are collectively referred to as L-headers). That is, for example, a radio communication apparatus supporting the IEEE 802.11a/b/g standard is capable of properly receiving L-headers in a PPDU corresponding to the IEEE802.11n/ac standard. The radio communication apparatus supporting the IEEE 802.11a/b/g standard can receive a PPDU corresponding to the IEEE802.11n/ac standard as a PPDU corresponding to the IEEE 802.11a/b/g standard.

However, the radio communication apparatus supporting the IEEE 802.11a/b/g standard is unable to demodulate a PPDU corresponding to the IEEE802.11n/ac standard following the L-headers, so the radio communication apparatus supporting the IEEE 802.11a/b/g standard cannot demodulate a transmission address (Transmitter Address (TA)), a reception address (Receiver Address (RA)), and information related to the Duration/ID field used for configuration of a NAV.

As a method for a radio communication apparatus supporting the IEEE 802.11a/b/g standard to configure the NAV appropriately (or to perform a reception operation in a prescribed period), IEEE802.11 defines a method of inserting Duration information into an L-SIG. Information related to the transmission rate in an L-SIG (RATE field, L-RATE field, L-RATE, L_DATARATE, L_DATARATE field), and information related to the transmission period (LENGTH field, L-LENGTH field, L-LENGTH) are used to for the radio communication apparatus supporting the IEEE 802.11a/b/g standard to configure the NAV appropriately.

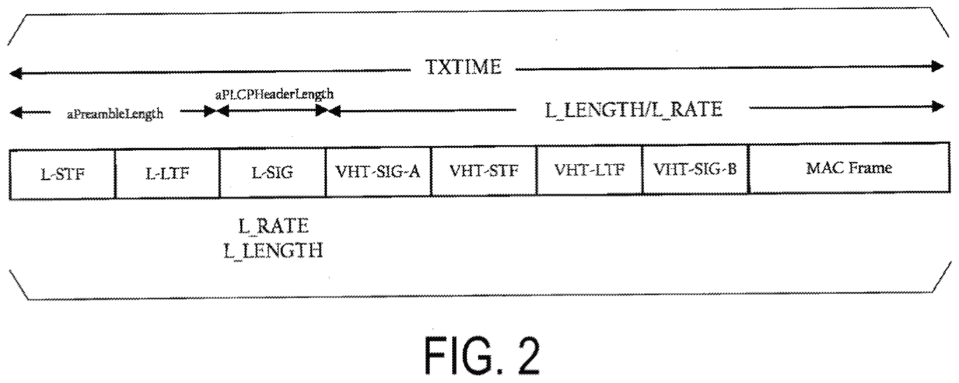

FIG. 2 is a diagram illustrating an example of a relationship between Duration information inserted into an L-SIG and a PPDU configuration. In FIG. 2, a PPDU configuration corresponding to the IEEE802.11ac standard is illustrated as an example, but the PPDU configuration is not limited thereto. The PPDU configuration may be a PPDU configuration corresponding to the IEEE802.11n standard or a PPDU configuration corresponding to the IEEE802.11ax standard. TXTIME includes information related to the length of the PPDU, aPreambleLength includes information related to the length of the preamble (L-STF +L-LTF), and aPLCPHeaderLength includes information related to the length of the PLCP header (L-SIG). Equation (1) below is a mathematical expression illustrating an example of a calculation method for the L_LENGTH.

$$Equation 1$$

$$L\_LENGTH = ⌈ \frac{\begin{matrix}( ( TXTIME - SignalExtension ) - \\ ( aPreambleLength + aPLCPHeaderLength ) )\end{matrix}}{aSymbolLength} ⌉ \times {N}_{ops} - ⌈ \frac{\begin{matrix}aPLCPServiceLength + \\ aPLCPConvolutionalTaiLength\end{matrix}}{8} ⌉ \qquad ( 1 )$$

Here, Signal Extension is a virtual period configured for compatibility of, for example, the IEEE802.11 standard, and Nₒₚₛ indicates information related to the L_RATE. aSymbolLength is information related to a period of one symbol (OFDM symbol or the like), aPLCPServiceLength indicates the number of bits included in the PLCP Service field, and aPLCPConvolutionalTailLength indicates the number of tail bits of a convolutional code. The radio communication apparatus can calculate L_LENGTH by using Equation (1) and insert it into the L-SIG, for example. Note that the calculation method of the L_LENGTH is not limited to Equation (1). For example, the L_LENGTH can be calculated by the following Equation (2).

$$Equation 2$$

$$L\_LENGTH = ⌈ \frac{( ( TXTIME - SignalExtension ) - 20 )}{4} ⌉ \times 3 - 3 \qquad ( 2 )$$

In a case that the radio communication apparatus transmits a PPDU by L-SIG TXOP Protection, the L_LENGTH is calculated by Equation (3) below or Equation (4) below.

$$\begin{matrix} Equation 3 & \\ L\_LENGTH = ⌈ \frac{\begin{matrix}( ( L - SIGDuration - SignalExtension ) - \\ ( aPreambleLength + aPLCPHeaderLength ) )\end{matrix}}{aSymbolLength} ⌉ \times {N}_{ops} - ⌈ \frac{\begin{matrix}aPLCPServiceLength + \\ aPLCPConvolutionalTaiLength\end{matrix}}{8} ⌉ & ( 3 ) \\ Equation 4 & \\ L\_LENGTH = ⌈ \frac{( ( L - SIGDuration - SignalExtension ) - 20 )}{4} ⌉ \times 3 - 3 & ( 4 )\end{matrix}$$

Here, L-SIG Duration indicates information related to a period in which periods of the PPDU including L_LENGTH calculated by, for example, Equation (3) or Equation (4) and an Ack and an SIFS which are expected to be transmitted from the destination radio communication apparatus as a response. The radio communication apparatus calculates the L-SIG Duration according to the Equation (5) below or Equation (6) below.

Equation 5

L−SIGDuration=(T_{init_PPDU}−(αPreambleLength+αPLCPHeaderLength))+SIFS+T_{Res_PPDU} (5)

Equation 6

L−SIGDuration(T_{MACDur}−SIRS+(αPreambleLength+αPLCPHeaderLength)) (6)

Here, Tinit PPDU indicates information related to the period of the PPDU including the L_LENGTH calculated by Equation (5), and TRes PPDU indicates information related to the PPDU period of the expected response for the PPDU including the L_LENGTH calculated by Equation (5). T_{MACDur} indicates information related to the Duration/ID field value included in the MAC frame in the PPDU including the L_LENGTH calculated by Equation (6). In a case that the radio communication apparatus is an Initiator (starter, sender, leader, Transmitter), L_LENGTH is calculated by using equation (5) and in a case that the radio communication apparatus is a Responder (counterpart, recipient, Receiver), L_LENGTH is calculated by using Equation (6).

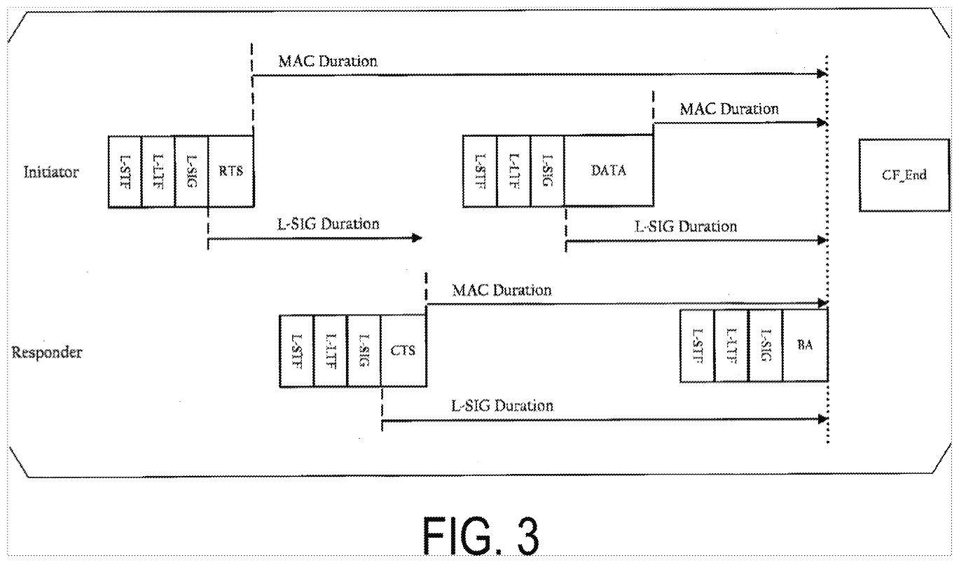

FIG. 3 is a diagram illustrating an example of an L-SIG Duration in L-SIG TXOP Protection. The DATA (frame, payload, data, etc.) includes part or both of the MAC frame and the PLCP header. Additionally, the BA is a Block Ack or an Ack. The PPDU can include an L-STF, an L-LTF, and an L-SIG, and can further include either or some of a DATA, a BA, an RTS, and a CTS. In the example illustrated in FIG. 3, the L-SIG TXOP Protection using RTS/CTS is illustrated, but CTS-to-Self may be used. Here, a MAC Duration is a period indicated by the value of the Duration/ID field. The Initiator can transmit a CF_End frame to notify the end of the L-SIG TXOP Protection period.

Next, a method for identifying a BSS from a frame received by the radio communication apparatus will be described. In order for the radio communication apparatus to identify the BSS from the received frame, it is preferable to insert information (BSS color, BSS identification information, BSS unique value) for the radio communication apparatus transmitting a PPDU to identify the BSS in the PPDU. Information indicating BSS color can be described in HE-SIG-A.

The radio communication apparatus can transmit an L-SIG multiple times (L-SIG Repetition). For example, the radio communication apparatus of the receiver side receives an L-SIG transmitted multiple times by using Maximum Ratio Combining (MRC) to improve demodulation accuracy of the L-SIG. Further, the radio communication apparatus may interpret the PPDU including the L-SIG as a PPDU corresponding to the IEEE802.11ax standard, in a case of successfully receiving the L-SIG by MRC.

The radio communication apparatus can perform a reception operation (also referred to as dual reception operation) of a part of a PPDU other than the PPDU (for example, a preamble, an L-STF, an L-LTF, a PLCP header, and the like. defined by IEEE802.11) during the PPDU reception operation. The radio communication apparatus can update some or all of information related to the destination address, the source address, and the PPDU or DATA period, in a case of detecting a part of a PPDU other than the PPDU during the PPDU reception operation.

The Ack and the BA may also be referred to as responses (response frames). The probe response, the authentication response, and the connection response can be referred to as responses.

### First Embodiment

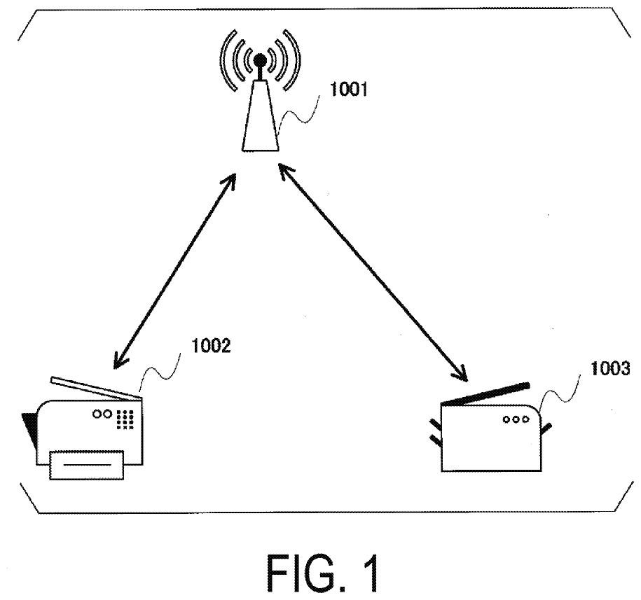

An embodiment of the present invention will be described in detail below with reference to the drawings. FIG. 1 illustrates an example of a device configuration according to the present embodiment. 1001 is an access point (AP) with a wireless LAN function such as IEEE802.11 specification as a communication scheme and a Wake up (WU) radio (WUR) function to wake-up a connected station (STA) from a sleep state, and 1002, and 1003 are STAs capable of wirelessly communicating by using a wireless LAN function (Primary radio (PR) and a Main radio (MR)), and waking-up from the access point 1001 by the WU wireless function from a standby state. In a case that the station 1002 or 1003 is, in a connection state capable of communicating with the access point 1001, determines that a device is not in use, or determines that radio communication is temporally not in use, the station 1002 or 1003 can transition to a sleep state that pauses communication by wireless LAN with the access point 1001. The access point 1001 can release the sleep state of the station 1002 or 1003 and return to a connection state capable of communicating, by transmitting a WU radio packet to either or both of the stations 1002 and 1003.

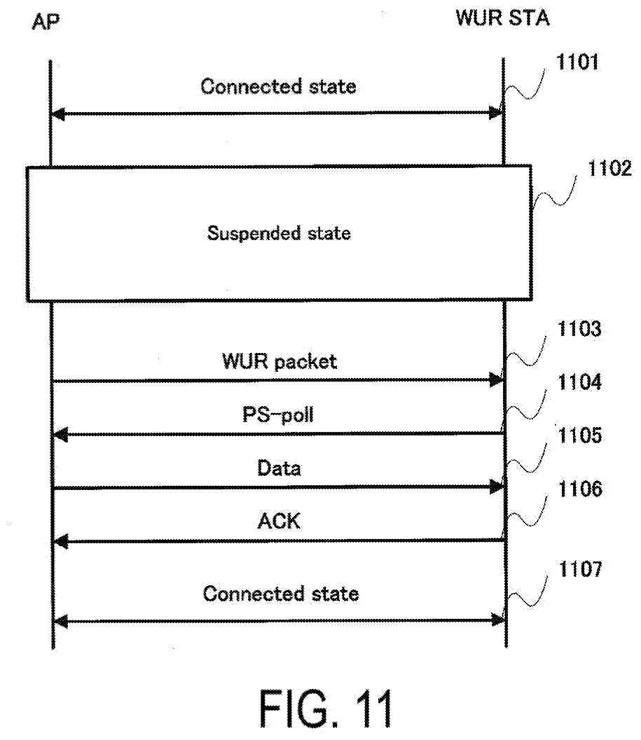

Referring now to FIG. 11, an example of a process flow is described in which the station 1002 transitions a communication state with the access point 1001 from a connected state to a suspended state and returns to the connected state by a WU radio packet from the suspended state. Suppose that a communication state is in the connection mode where wireless LAN communication is performed between the access point 1001 and the station 1002 at 1101. The station 1002 then transitions to a suspended state at 1102, stops the wireless LAN function, and transitions a standby mode that receives only a WU radio signal (wake-up radio signal, WU radio frame, WU data frame, WU frame). The procedure for transitioning to this standby mode is not particularly specified, but, as examples, a method for automatically transitioning to a standby mode in a case that the time in which there in no communication in the station 1002 exceeds a prescribed time, a method of making a notification to transition to a standby mode from the station 1002 to the access point 1001, a method for requesting the transition to the standby mode from the access point 1001 to the station 1002, and the like can be used. After the station 1002 transitions to the standby mode, the access point 1001 transmits a WU radio packet to the station 1002 in step 1103 in a case that transmission data for the station 1002 occurs at the access point 1001. The station 1002 having received the WU radio packet places the wireless LAN function ready to use and then transmits a PS-poll packet to the access point 1001 in step 1104 to notify that the station 1002 can receive data from the access point 1001. The packet transmitted at this time may not be ps-Poll, and a packet such as an NDP packet without data may be used. The access point 1001 having received the ps-Poll packet determines that the station 1002 has returned to the connected mode and communicates with the station 1002 at step 1107.

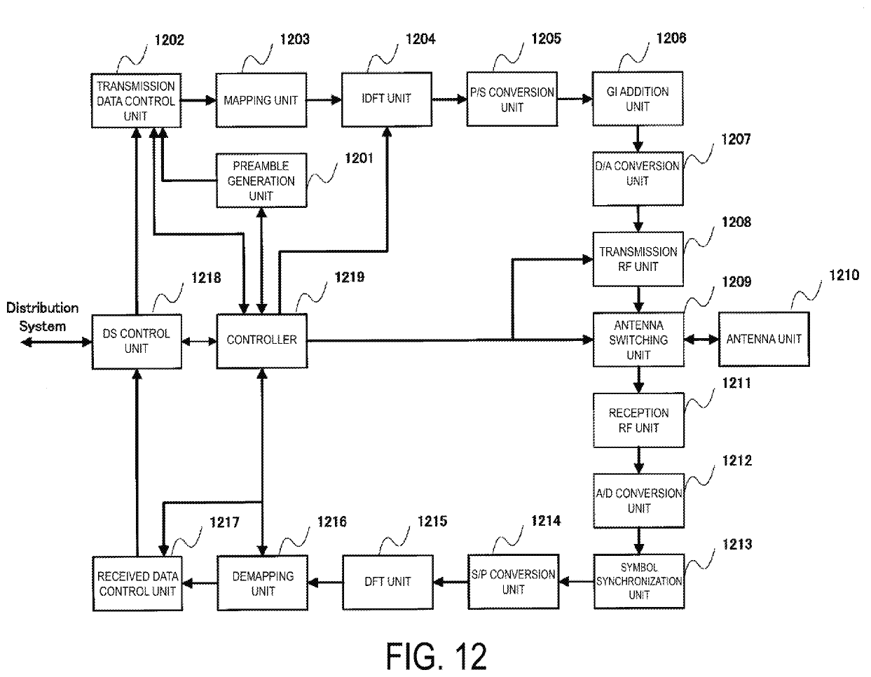

An example of a configuration overview of the access point 1001 will be described with reference to FIG. 12. 1201 is a preamble generation unit that generates data of the preamble of a transmission packet by indication from the controller 1219, 1202 is a transmission data control unit that generates data to be allocated to each subcarrier of a transmission packet by indication from the controller 1219, based on output from the preamble unit 1201 and communication data input from the DS control unit 1218, 1203 is a mapping unit that configures an output from the transmission data control unit 1202 to each subcarrier of data symbols of the transmission packet, 1204 is an IDFT unit that performs inverse discrete Fourier transform (IDFT) processing on data configured for each subcarrier by the mapping unit 1203, 1205 is a parallel to serial (P/S) conversion unit that rearranges output of the IDFT unit 1204 in a transmission order, 1206 is a GI addition unit that adds a guard interval (GI) to data input from the P/S conversion unit 1205, 1207 is a D/A conversion unit that performs digital to analog (D/A) conversion on the data of the baseband where the guard interval is added by the GI addition unit 1206, 1208 is a transmission RF unit that transforms an analog baseband signal input from the D/A conversion unit 1207 into frequency to be transmitted from the antenna unit 1210 to amplify to a desired power, 1209 is an antenna switching unit that switches a connection destination of an antenna unit 1210 to either of the transmission RF unit 1208 or a reception RF unit 1211, 1210 is an antenna unit that performs transmission and reception of a signal of a certain frequency, 1211 is a reception RF unit that inputs the signal received by the antenna unit 1210 via the antenna switching unit 1209, and transforms into a baseband signal, 1211 is an A/D conversion unit that performs analog to digital (A/D) conversion on the analog baseband signal input by the reception RF unit, 1213 is a symbol synchronization unit that detects a preamble from the baseband signal performed A/D conversion, removes a guard interval along with the symbol timing to the S/P conversion unit 1214, and outputs a received signal after the removal of the guard interval, 1214 is a P/S conversion unit that makes the input signal to be parallel by serial to parallel (P/S) conversion and transforms to a format capable of discrete Fourier transform (DFT) processing, 1215 is a DFT unit that performs DFT processing on the input signal, 1216 is a demapping unit that estimates demodulated data by using the signal after the DFT processing from the signal point of each subcarrier, 1217 is a received data control unit that extracts the structure of the packet from the data after the demapping, checks whether the received packet does not include an error, and outputs the payload of the packet to the DS control unit or controller 1219 in a case that there is no error, 1218 is a DS control unit that exchanges received data, transmission data with distribution system (DS) to connect with the network, and 1219 is a controller that monitors the state of each block and controls each block according to a predetermined procedure.

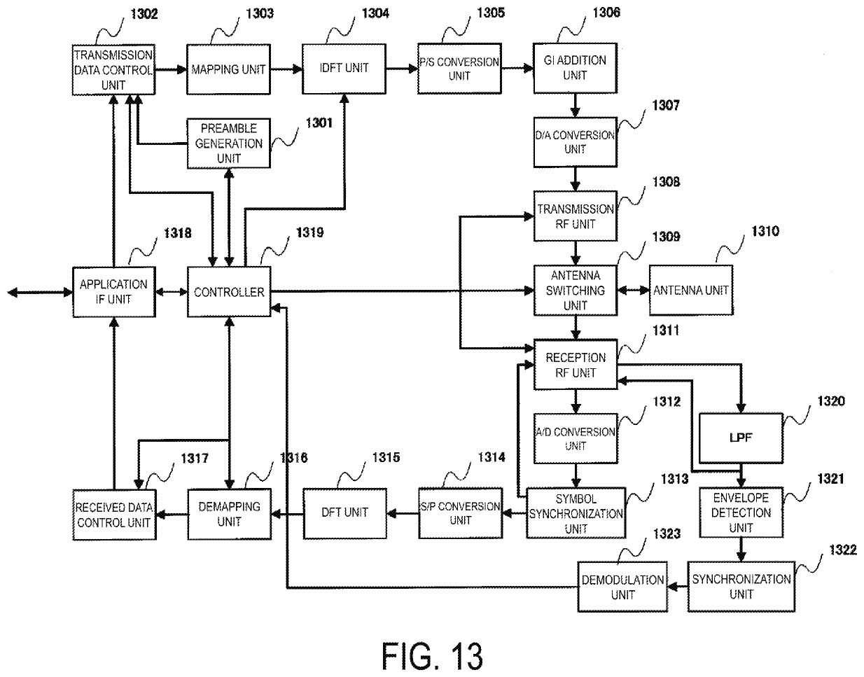

An example of a configuration overview of the stations 1002 and 1003 will be described with reference to FIG. 13. The configuration overviews of the stations 1002 and 1003 are both the same. 1301 is a preamble generation unit that generates data of the preamble of a transmission packet by indication from the controller 1319, 1302 is a transmission data control unit that generates data to be allocated to each subcarrier of a transmission packet by indication from the controller 1319, based on output from the preamble unit 1301 and communication data input via the application IF unit 1318, 1303 is a mapping unit that configures an output from the transmission data control unit 1302 to each subcarrier of data symbols of the transmission packet, 1304 is an IDFT unit that performs inverse discrete Fourier transform (IDFT) processing on data configured for each subcarrier by the mapping unit 1303, 1305 is a parallel to serial (P/S) conversion unit that rearranges output of the IDFT unit 1304 in a transmission order, 1306 is a GI addition unit that adds a guard interval (GI) to data input from the P/S conversion unit 1305, 1307 is a D/A conversion unit that performs digital to analog (D/A) conversion on the data of the baseband where the guard interval is added by the GI addition unit 1306, 1308 is a transmission RF unit that transforms an analog baseband signal input from the D/A conversion unit 1307 into frequency to be transmitted from the antenna unit 1310 to amplify to a desired power, 1309 is an antenna switching unit that switches a connection destination of an antenna unit 1310 to either of the transmission RF unit 1308 or a reception RF unit 1311, 1310 is an antenna unit that performs transmission and reception of a signal of a certain frequency, 1311 is a reception RF unit that inputs the signal received by the antenna unit 1310 via the antenna switching unit 1309, and transforms into a baseband signal, 1311 is an A/D conversion unit that performs analog to digital (A/D) conversion on the analog baseband signal input by the reception RF unit, 1313 is a symbol synchronization unit that detects a preamble from the baseband signal performed A/D conversion, removes a guard interval along with the symbol timing to an S/P conversion unit 1314, and outputs a received signal after the removal of the guard interval, 1314 is a P/S conversion unit that makes the input signal to be parallel by serial to parallel (P/S) conversion and transforms to a format capable of discrete Fourier transform (DFT) processing, 1315 is a DFT unit that performs DFT processing on the input signal, 1316 is a demapping unit that estimates demodulated data by using the signal after the DFT processing from the signal point of each subcarrier, 1317 is a received data control unit that extracts the structure of the packet from the data after the demapping, checks whether the received packet does not include an error, and outputs the payload of the packet to the DS control unit or controller 1319 in a case that there is no error, 1318 is a DS control unit that exchanges received data, transmission data with distribution system (DS) to connect with the network, 1320 is a lowpass filter (LPF) unit that extracts a signal of the band of the WU radio signal from the received baseband signal, 1321 is an envelope detection unit that performs envelope detection on the output signal of the LPF unit 1320, 1322 is a synchronization unit that detects the preamble of the WU radio signal from the output signal of the envelope detection unit 1321, 1323 is a demodulation unit that demodulates a signal after the preamble of the WU radio packet, and 1319 is a controller that monitors the state of each block and controls each block according to a predetermined procedure.

The stations 1002 and 1003 may control the power supply state of blocks constituting the stations 1002 and 1003 in each of the connected state in which communication of wireless LAN is performed and the standby mode state in which the function of receiving a WU radio signal is used to make power consumption adequate. As an example, in the connected state, the power consumed by the LPF unit 1320, the envelope detection unit 1321, the synchronization unit 1322, and the demodulation unit 1323 may be stop, and in the standby mode, the antenna switching unit 1309, the reception RF unit 1311. the LPF unit 1320, the envelope detection unit 1321, the synchronization unit 1322, the demodulation unit 1323, and the controller 1319 may only operate, and the power consumed by other blocks may be stopped. In a case that the configuration of the antenna switching unit 1309 is configured so that the antenna unit 1310 and the reception RF unit 1311 are connected in a case that the power is not supplied, the power supply of the antenna switching unit 1309 may be stopped. The configuration of the reception RF unit 1311 may be configured so that the power consumption of the reception RF unit 1311 is smaller in a case of handling a WU radio signal than a case of handling a wireless LAN signal.

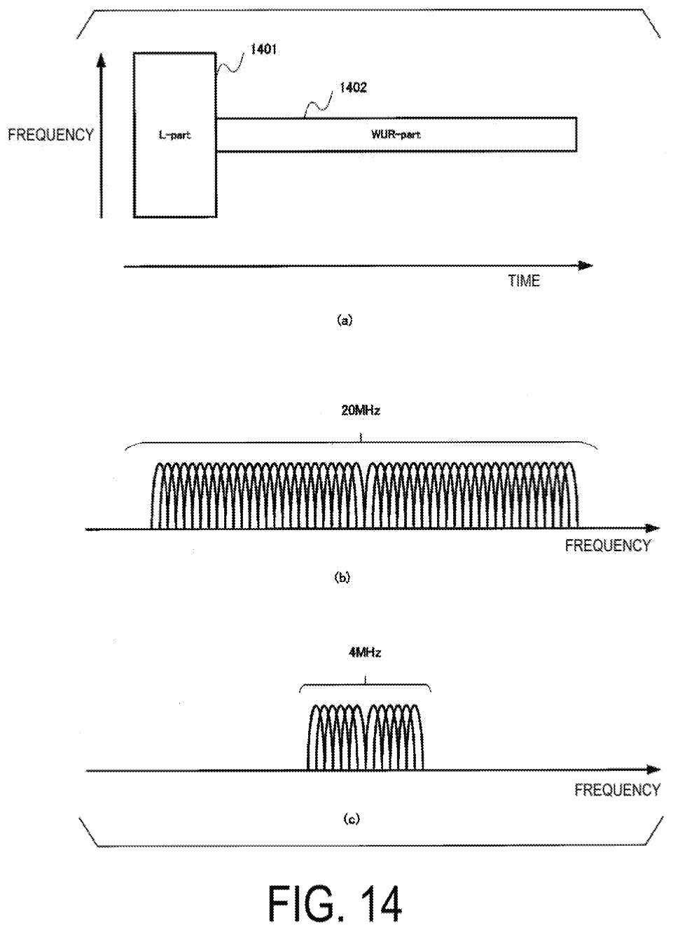

FIG. 14 illustrates an example of a configuration of a WU radio signal. In FIG. 14(a), the vertical axis direction indicates the frequency band occupied by the signal, and the horizontal axis indicates occupancy time in the time direction. 1401 is a signal that can be received by stations that are not capable of receiving WU radio signals, using signals that are compatible with conventional wireless LAN signals in a legacy part (L-part). 1402 is a signal for stations that can receive WU radio signals in a WU radio part (WUR-part). As illustrated in FIG. 14(a), initially the L-part 1401 is transmitted followed by the WUR-part 1402. The WUR-part 1402 uses a signal format with a band narrower than the L-part 1401 and with slower information speed to reduce power used during demodulation.

In this embodiment, a signal of the L-part 1401 and a signal of the WUR-part 1402 are generated by using IDFT. FIG. 14(b) is a schematic diagram of a subcarrier allocation prior to IDFT processing in generating the L-part 1401. As an example, in a case that the number of IDFT processing points is 64 (the index range is −32 to 31), subcarriers are placed in the range of indexes −26 to 26, to place the baseband signal after IDFT within a prescribed band, for example, 20 MHz. Note that index 0 is not used as a direct current (DC) carrier. The value configured for the subcarrier of IDFT is not particularly limited, but for example, the values used in the Short Training Field (STF), Long Training Field (LTF), and SIGnal (SIG) field defined by the IEEE802.11a standard may be used. Note that the number of IDFT points is not limited to 64, and, for example, 128 points of IDFT may be used for 40 MHz band, or 256 points of IDFT may be used for 80 MHz band. In a case of using 128 points or 256 points of IDFT, the value of the subcarriers used in a case of using 64 points of IDFT may be replicated and the desired value of the number of points may be prepared. FIG. 14(c) is a schematic diagram of a subcarrier allocation prior to IDFT processing in generating the WUR-part 1402. As an example, in a case that the number of IDFT processing points is 64, subcarriers are placed in the range of indexes −6 to 6, and the baseband signal after IDFT falls within 4 MHz, for example. Note that index 0 is not used as a DC carrier. The value configured for the subcarrier during WUR signal transmission is not particularly specified, but as an example, a method of using the value of a subcarrier used in the STF or the LTF of IEEE802.11a, for example, and a method of using a part of a pseudo-random number sequence such as an M sequence, and the like during preamble transmission of the L-part may be used.

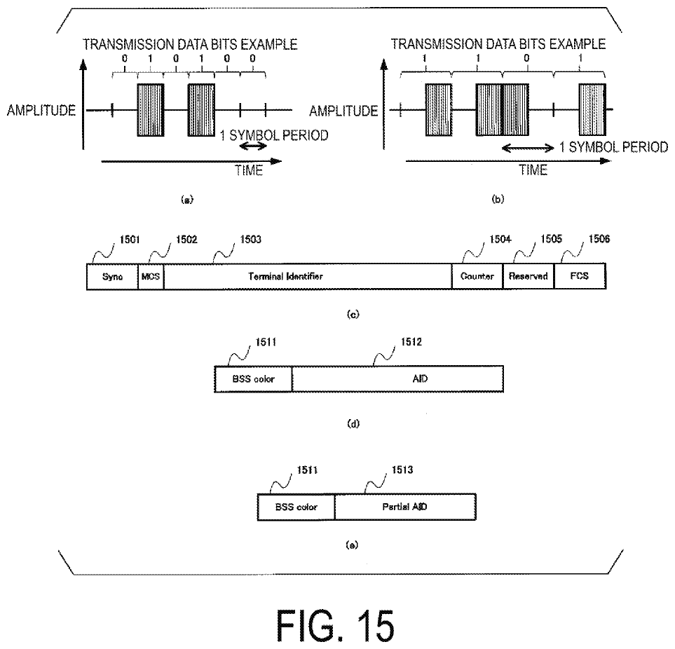

At the station of the receiver side, the WU radio signal is in a form capable of envelope detection in order to reduce power used during demodulation of the WU radio signal. In the present embodiment, an on-off-keying (OOK) modulation scheme is used. In the present embodiment, two types of encoding using no codes (not using codes) and using the Manchester code are used as the coding of data, but one type of coding method may be used, and more than two types may be used. An example of a WU radio signal in a case of performing no-code OOK modulation is illustrated in FIG. 15(a). The modulation symbol uses a prescribed time as a unit, and the presence or absence of an amplitude of the WU radio signal is assigned to a transmission data bit. In the present embodiment, the amplitude 0 is assumed to be 0 in the transmission bit, and a state in which prescribed data is configured for the subcarrier used for the transmission and the amplitude of the WU radio signal is thus presented assumed to be 1 in the transmission bit. An example of the WU signal in a case that OOK modulation is performed by using the Manchester code is illustrated in FIG. 15(b). Two modulation symbols after no-code OOK modulation are assumed to be a coding unit, and a modulation symbol after coding by using the Manchester code is used. In the present embodiment, a state in which the no-code OOK modulation symbols are arranged with 0, 1 is referred to as pre-coding transmission data bit 1, and a state in which the no-code OOK modulation symbols are arranged with 1, 0 is referred to as the pre-coding transmission data bit 0.

An overview of the WU radio frame structure used in the WUR-part 1402 of FIG. 14(a) is illustrated in FIG. 15(c). 1501 a synchronization part for use in synchronization and is configured with a prescribed number and value of OOK modulation symbols. For example, the synchronization part may be composed of four OOK modulation symbols and the transmission data bits may be 1, 0, 1, 0 in row. 1502 is a field indicating a Moduration and Coding Scheme (MCS) of subsequent modulation symbols, and indicates a case of using no-code OOK modulation with 1, 0 sequence OOK modulation symbols, and indicates a case of using OOK modulation that uses the Manchester code with 0 and 1 sequence OOK modulation symbols. This is equivalent to transmitting 0 or 1 information for identifying MCS by using the Manchester code. As a result, the terminal identifier field 1503, the counter field 1504, the reservation field 1505, and the FCS field 1506 are transmitted in the modulation scheme indicated in the MCS field 1502.

The MCS for use in the terminal identifier field 1503, the counter field 1504, the reservation field 1505, and the FCS field 1506 may be notified in other ways while omitting the MCS field. As an example, multiple sequences of transmission data bits to be used in the synchronization part may be provided, and the MCS may be notified by using any of the multiple sequences. For example, in a case that the sequence of 1, 0, 1, 0 is used for the synchronization part, OOK modulation using the Manchester code may be used, and in a case that 1, 0, 0, 1 is used, no-code OOK modulation may be used.

1503 is a terminal identifier field and includes information used to identify both or one of the access point transmitting the WU radio signal and the station receiving the WU radio signal. The information included in the terminal identifier field does not completely identify the access point or station, and the length of the terminal identifier field may be shortened by using information that may be assigned to multiple access points or multiple stations. As an example of this shortening method, BSS color 1511 and an association identifier field (Association IDentifier (AID)) 1512 as illustrated in FIG. 15(d) may be configured, or BSS color 1511 and shortened AID (Partial AID) 1513 as illustrated in FIG. 15(e) may be configured. BSS color is information that would be employed for the IEEE802.11ax specification for which the standardization operation is currently being advanced, defines a shorter information length than the MAC address (48 bits) for approximate differentiation of access points, for example, 6-bit length information, and is adjusted between access points to configure different values as possible between neighboring access points. AID 1512 is an identifier assigned to a station from an access point in a case that the station connects (performs Association process) to the access point, and is assigned with 1 to 1023 with 12 bit length information for the IEEE802.11 specification. Partial AID 1513 is defined by the IEEE802.11ac specification and is 9-bit long information with AID shortened in a prescribed manner. AID 1512 and Partial AID 1513 are shorter information than the MAC address (48 bits) and may overlap between stations connected to respective access points in a case that multiple access points are operated adjacent. Partial AID 1513 may overlap between multiple stations that are connected to one access point. Processing in a case that the information in the terminal identifier field 1503 overlaps among multiple stations will be described later.

1504 is a counter field and is used in the retry process and reconnection process. As an example, a 4-bit long counter may be used configuring all 0 for the first time transmission of the WU radio signal. 1505 is a reservation field and is used for additional functions. The field length is not particularly specified, but as an example, a 4-bit reservation field 1505 may be provided. The reservation field 1505 may be omitted in a case that future function addition is not performed. 1506 is a Frame Check Sequence (FCS) field, and includes a value for verifying if the received data included in the reservation field 1505 is correct from the terminal identifier field 1503. As an example, Cyclic Redundancy Check (CRC) code, for example, CRC-8, with a length of the generated polynomial of 9 bits, may be used.

The stations 1002 and 1003 in the standby mode for receiving a WU radio signal detect a condition that the output power of the LPF unit 1320 changes from below a prescribed threshold to above a prescribed threshold to determine that the L-part 1401 is received, and check that the output of the envelope detection unit 1321 changes to data bits sequence used in the synchronization part 1501 by the synchronization unit 1322, for example 1, 0, 1, 0, to start demodulation of the WU radio signal frame. The station that has detected the synchronization part 1501 receives the MCS field 1502 that follows, and estimates the MCS of the fields after the MCS field 1502. The stations 1002 and 1003 utilize this estimated result to demodulate the subsequent fields. The stations 1002 and 1003 demodulate all of the terminal identifier field 1503, the counter field 1504, the reservation field 1505, and the FCS field 1506, and utilize the value in the FCS field 1506 to determine if the terminal identifier field 1503, the counter field 1504, and the reservation field 1505 have been successfully demodulated, and in a case of having successfully demodulated, determine that the terminal identifier field 1503 specifies the station itself. In a case that the terminal identifier field 1503 is a value specifying the station itself, the stations 1002 and 1003 supply the power to blocks for communication by using the wireless LAN signal of the stations 1002 and 1003 to recover a state in which communication using the wireless LAN signal can be performed. After the communication has been enabled by using the wireless LAN signal, the stations 1002 and 1003 transmit a packet, for example, a ps-Poll packet, that notifies the access point 1001 of waking-up, and prompt the access point 1001 to transmit data to the stations. ONote that, after receiving the MCS field 1502, at the time of receiving the terminal identifier field 1503, the value of the terminal identifier field 1503 may be checked without waiting for reception of the FCS field 1506. In a case that the value is not a value corresponding to the station itself, subsequent demodulation processing may be stopped, and power consumption of the demodulation unit 1323 may be reduced until a next WU radio signal is detected. At this time, rather than checking all of the values of the terminal identifier field 1503, a part initially transmitted in the terminal identifier field 1503, for example, a value of BSS color 1511 may be checked, and subsequent demodulation may be stopped in a case that the value is not a value corresponding to the station itself.

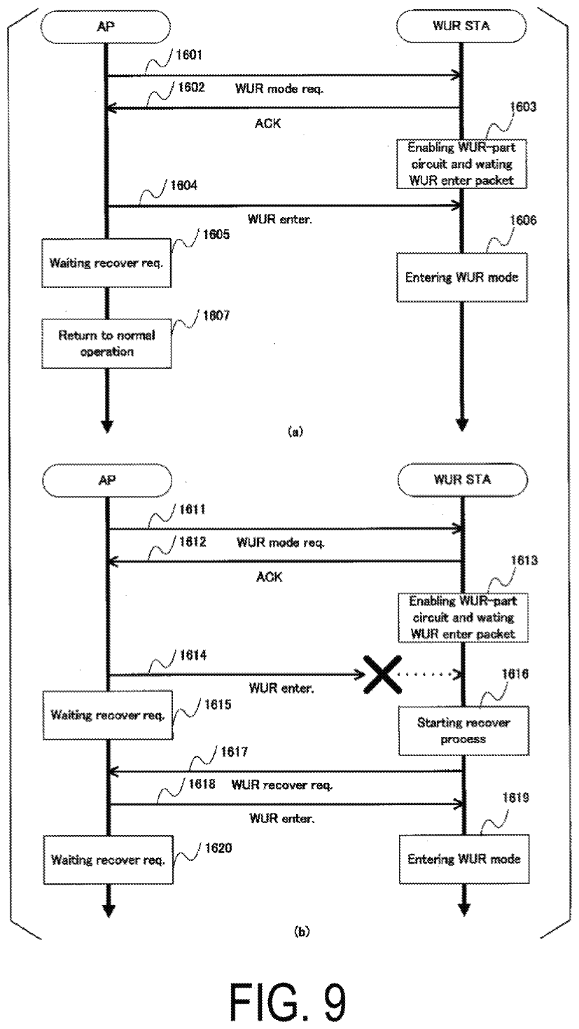

An example of communication between the access point 1001 and the station 1002 or the station 1003 is described by using the message flow diagram of FIG. 9. FIG. 9 illustrates a flow in a case of requesting from the access point 1001 to the station 1002 or the station 1003 to transition to a standby mode as signaling for transitioning the station 1002 (1003) to the standby state. FIG. 9(a) illustrates a message flow in a case that the delivery of the WU radio signal is successful, and FIG. 9(b) illustrates a message flow in a case that the delivery of the WU radio signal is unsuccessful. Initially, at 1601, a WUR mode request packet (wake-up radio mode request packet) is transmitted from the access point 1001 to the station 1002 (1003) by using a wireless LAN signal. The station 1002 (1003) having received this WUR mode request packet transmits an acknowledgement response (ACK) packet for the WUR mode request packet to the access point 1001 with a wireless LAN signal at 1602. Thereafter, the station 1002 (1003) supplies the power to blocks used to receive the WU radio signal at 1603, as an example, the LPF unit 1320, the envelope detection unit 1321, the synchronization unit 1322, and the demodulation unit 1323 of FIG. 13, to enable each block to be used to receive these WU radio signals. In a case that the station 1002 (1003) is configured to be always able to receive WU radio signals, this procedure may be omitted. The access point 1001 having received the acknowledgement response packet of 1602 transmits a WUR transition packet by using a WU radio signal to the station 1002 (1003) at 1604. Prior to transitioning to this flow of 1604, the access point 1001 may consider time to allow each block to be used for the station 1002 (1003) to receive the WU radio signal at 1603, and wait for the operation of 1604. The access point 1001 that has transmitted the WUR transition packet at 1604 waits for a WUR recovery request packet (wake-up radio recovery request packet) to be transmitted from the station 1002 (1003) by using a wireless LAN signal at 1605. Thereafter, after waiting for a predetermined time, for example, 5 milliseconds, the access point 1001 returns to normal operation at 1607 in a case of not having received the WUR recovery request packet. The station 1002 (1003) having received a WUR transition packet utilizing the WU radio signal of 1604 transitions to a standby state (WUR mode) at 1606.

Next, a flow in a case that the delivery of a WU radio signal is unsuccessful will be illustrated. Initially, at 1611, a WUR mode request packet is transmitted from the access point 1001 to the station 1002 (1003) by using a wireless LAN signal. The station 1002 (1003) having received this WUR mode request packet transmits an acknowledgement response (ACK) packet for the WUR mode request packet to the access point 1001 with a wireless LAN signal at 1612. Thereafter, the station 1002 (1003) supplies the power to blocks used to receive the WU radio signal at 1613, as an example, the LPF unit 1320, the envelope detection unit 1321, the synchronization unit 1322, and the demodulation unit 1323 of FIG. 13, to enable each block to be used to receive these WU radio signals. In a case that the station 1002 (1003) is configured to be always able to receive WU radio signals, this procedure may be omitted. The access point 1001 having received the acknowledgement response packet of 1612 transmits a WUR transition packet by using a WU radio signal to the station 1002 (1003) at 1614. Prior to transitioning to this flow of 1614, the access point 1001 may consider time to allow each block to be used for the station 1002 (1003) to receive the WU radio signal at 1613, and wait for the operation of 1614. The access point 1001 that has transmitted the WUR transition packet at 1614 waits for a WUR recovery request packet to be transmitted from the station 1002 (1003) by using a wireless LAN signal at 1615. The station 1002 (1003) waits for a WU transition request packet to be received utilizing a WU radio signal, but fails to receive the WUR transition packet transmitted at 1614. After the WUR transition packet is failed to be received for a predetermined time, for example, 2 milliseconds after 1613, a recovery procedure is initiated at the station 1616. The station 1002 (1003) that has been transitioned to the recovery procedure transmits a WUR recovery request packet to the access point 1001 by using a wireless LAN signal at 1617. The station 1002 (1003) then waits for reception of the WUR transition packet utilizing the WU radio signal. The access point 1001 having received the WUR recovery request packet of 1617 utilizes a WU radio signal to transmit a WUR transition packet at 1618. The access point 1001 then waits for the WUR recovery request packet utilizing the wireless LAN signal to be received for a predetermined time at 1620. In a case that this WUR recovery request packet is not received, the access point 1001 returns to a normal operation. The station 1002 (1003) having received the WUR transition request packet of 1618 terminates the recovery process and transitions to a standby state at 1619.

For simplicity of transition of the message flow of FIG. 9, the exchange of WUR mode request packets 1601 and 1611 and acknowledgement response packets 1602 and 1612 using wireless LAN signals is assumed as signaling for WUR transition, standby states 1606 and 1619 utilizing WU radio signals are assumed as a WUR mode or a WU radio standby mode, and a period including signaling for the WUR transition and exchanges of signals during the WU radio standby mode may be distinguished as a WUR transition state or a WU radio transition state. In this case, the recovery procedure is included in a WU radio transition state.

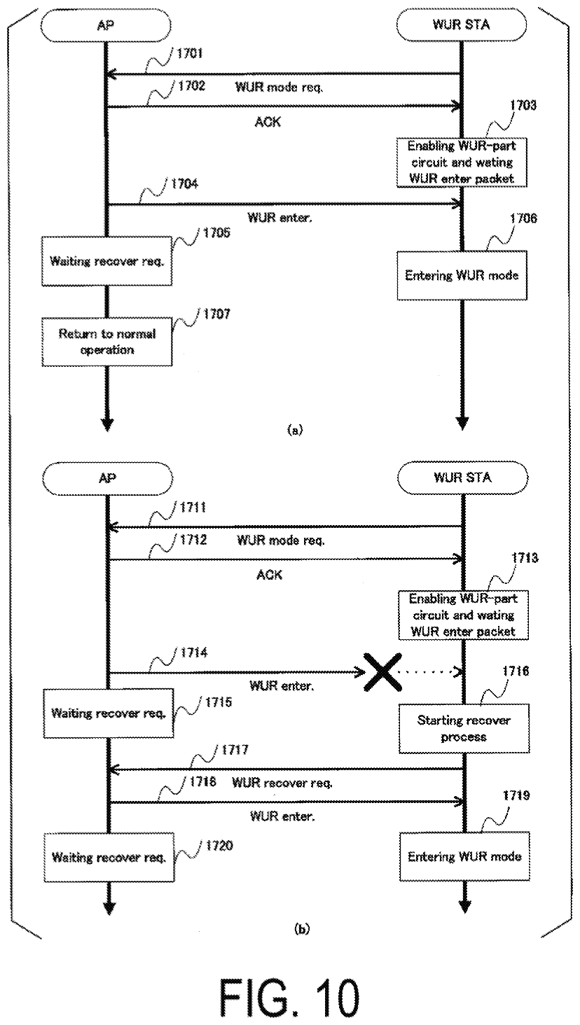

A flow is illustrated in FIG. 10 in a case of requesting from the station 1002 (1003) to the access point 1001 to transition the station itself 1002 (1003) to a standby state (WUR mode, wake-up radio mode) as signaling for transitioning the station 1002 or the station 1003 to the standby state. FIG. 10(a) illustrates a message flow in a case that the delivery of the WU radio signal is successful, and FIG. 10(b) illustrates a message flow in a case that the delivery of the WU radio signal is unsuccessful. The flow in a case the delivery of the WU radio signal is successful will be described. Initially, at 1701, a WUR mode transition request packet is transmitted from the station 1002 (1003) to the access point 1001 by utilizing a wireless LAN signal. The access point 1001 having received the WUR mode transition request packet of 1701 transmits an acknowledgement response for the WUR mode transition request packet of 1701 by utilizing a wireless LAN signal to the station 1002 (1003) at 1702. The station 1002 (1003) having received the acknowledgement response of 1702 supplies the power to blocks used to receive the WU radio signal at 1703, as an example, the LPF unit 1320, the envelope detection unit 1321, the synchronization unit 1322, and the demodulation unit 1323 of FIG. 13, to enable each block to be used to receive these WU radio signals. In a case that the station 1002 (1003) is configured to be always able to receive WU radio signals, this procedure may be omitted. The access point 1001 having transmitted the acknowledgement response at 1702 transmits a WUR transition packet by using a WU radio signal to the station 1002 (1003) at 1704. Prior to transitioning to this flow of 1704, the access point 1001 may consider time to allow each block to be used for the station 1002 (1003) to receive the WU radio signal at 1703, and wait for the operation of 1704. The access point 1001 that has transmitted the WUR transition packet at 1704 waits for a WUR recovery request packet to be transmitted from the station 1002 (1003) by using a wireless LAN signal at 1705. Thereafter, after waiting for a predetermined time, for example, 5 milliseconds, the access point 1001 returns to normal operation at 1707 in a case of not having received the WUR recovery request packet. The station 1002 (1003) having received a WUR transition packet utilizing the WU radio signal of 1704 transitions to a standby state (WUR mode) at 1706.

Next, a flow in a case that the delivery of a WU radio signal is unsuccessful will be illustrated. Initially, at 1711, a WUR mode transition request packet is transmitted from the station 1002 (1003) to the access point 1001 by utilizing a wireless LAN signal. The access point 1001 having received the WUR mode transition request packet of 1711 transmits an acknowledgement response for the WUR mode transition request packet of 1711 by utilizing a wireless LAN signal to the station 1002 (1003) at 1712. The station 1002 (1003) having received the acknowledgement response of 1712 supplies the power to blocks used to receive the WU radio signal at 1713, as an example, the LPF unit 1320, the envelope detection unit 1321, the synchronization unit 1322, and the demodulation unit 1323 of FIG. 13, to enable each block to be used to receive these WU radio signals. In a case that the station 1002 (1003) is configured to be always able to receive WU radio signals, this procedure may be omitted. The access point 1001 having transmitted the acknowledgement response at 1712 transmits a WUR transition packet by using a WU radio signal to the station 1002 (1003) at 1714. Prior to transitioning to this flow of 1714, the access point 1001 may consider time to allow each block to be used for the station 1002 (1003) to receive the WU radio signal at 1713, and wait for the operation of 1714. The access point 1001 that has transmitted the WUR transition packet at 1714 waits for a WUR recovery request packet to be transmitted from the station 1002 (1003) by using a wireless LAN signal at 1705. The station 1002 (1003) waits for a WU transition request packet to be received utilizing a WU radio signal, but fails to receive the WUR transition packet transmitted at 1714. After the WUR transition packet is failed to be received for a predetermined time, for example, 2 milliseconds after 1713, a recovery procedure is initiated at the station 1716. The station 1002 (1003) that has been transitioned to the recovery procedure transmits a WUR recovery request packet to the access point 1001 by using a wireless LAN signal at 1717. The station 1002 (1003) then waits for reception of the WUR transition packet utilizing the WU radio signal. The access point 1001 having received the WUR recovery request packet of 1717 utilizes a WU radio signal to transmit a WUR transition packet at 1718. The access point 1001 then waits for the WUR recovery request packet utilizing the wireless LAN signal to be received for a predetermined time at 1720. In a case that this WUR recovery request packet is not received, the access point 1001 returns to a normal operation. The station 1002 (1003) having received the WUR transition request packet of 1718 terminates the recovery process and transitions to a standby state at 1719.

For simplicity of transition of the message flow of FIG. 10, the exchange of WUR mode request packets 1701 and 1711 and acknowledgement response packets 1702 and 1712 using wireless LAN signals is assumed as signaling for WUR transition, standby states 1706 and 1719 utilizing WU radio signals are assumed as a WUR mode or a WU radio standby mode, and a period including signaling for the WUR transition and exchanges of signals during the WU radio standby mode may be distinguished as a WUR transition state or a WU radio transition state. In this case, the recovery procedure is included in a WU radio transition state.

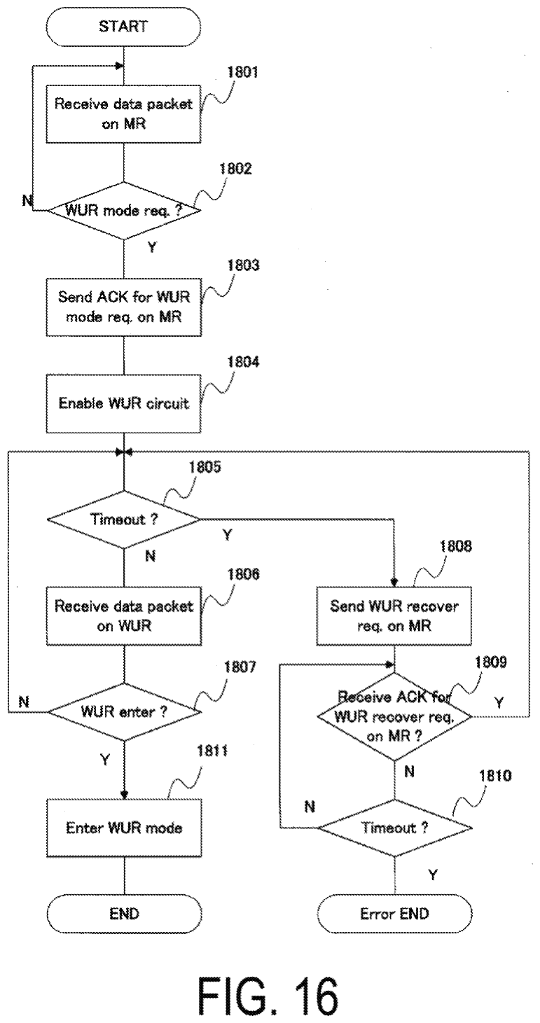

A control flow of the controller 1319 of the station 1002 (1003) to realize the message flow illustrated in FIG. 9 will be described with reference to FIG. 16. At 1801, the controller 1319 receives a data packet transmitted by using a wireless LAN signal from the access point 1001 to determine if the data packet is a WUR mode transition request packet at 1802. In a case of not the WUR mode transition request packet, the process returns to 1801, and in a case of the WUR mode transition request packet, the process proceeds to 1803. At 1803, the controller 1319 transmits an acknowledgement response for the WUR mode transition request packet received at 1801 to the access point 1001 by using a wireless LAN signal. Subsequently, at 1804, the controller 1319 supplies the power to blocks used to receive the WU radio signal, as an example, the LPF unit 1320, the envelope detection unit 1321, the synchronization unit 1322, and the demodulation unit 1323 of FIG. 13, to enable each block to be used to receive these WU radio signals. The order of 1803 and 1804 may be reversed or 1803 and 1804 may be performed simultaneously. Thereafter, at 1805, the controller 1319 performs a timeout determination of whether the WUR mode transition request packet has been received within a predetermined time. In a case of determining not a timeout, the process proceeds to 1806, and in a case of determining a timeout, the process proceeds to 1808. The controller 1319 receives the data packet using the WU radio signal at 1806, and determines whether the received data packet is the WUR mode transition request packet at 1807. In a case of the WUR mode transition request packet, the process proceeds to 1811, and in a case of not the WUR mode transition request packet, the process returns to 1805. At 1811, the controller 1319 transitions the station 1002 (1003) to the standby state (WUR mode) and terminates the flow. In order to perform the recovery procedure from 1808, the controller 1319 transmits a WUR recovery request packet to the access point 1001 by using a wireless LAN signal to determine if an acknowledgement response (ACK) packet for this WUR recovery request packet using the wireless LAN signal has been received at 1809. In a case that the reception is successful, the process returns to 1805, and in a case that the reception is failed, the process proceeds to 1810. The controller determines if the time configured to receive this acknowledgement response packet has elapsed to be timeout. In a case of not timeout, the process returns to 1809 again to receive the acknowledgement response packet, and in a case of determining timeout, the recovery process ends and the series of flows is terminated as an error. Although only one WUR recovery request packet has been transmitted in FIG. 16, the WUR recovery request packet may be transmitted again after the timeout determination and thus the WUR recovery request packet may be transmitted multiple times.

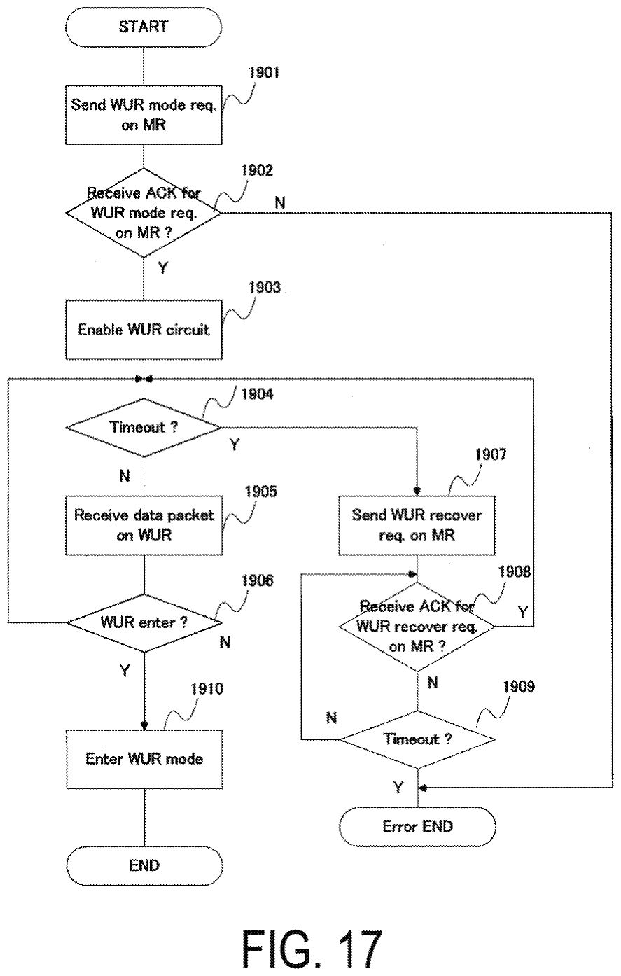

Next, a control flow of the controller 1319 of the station 1002 (1003) to realize the message flow illustrated in FIG. 10 will be described with reference to FIG. 17. At 1901, the controller 1319 transmits a WUR mode transition request packet to the access point 1001 by using a wireless LAN signal for the access point 1001. Thereafter, at 1902, the controller 1319 determines whether an acknowledgement response packet for the WUR mode transition request packet has been received, and the process proceeds to 1903 in a case the acknowledgement response packet has been received, and the process terminates the flow as an error in a case that the acknowledgement response packet has not been received. Before terminating the flow as this error, the process may return to 1301, and the controller 1319 may again transmit a WUR mode transition request packet to the access point 1001. At 1903, the controller 1319 supplies the power to blocks used to receive the WU radio signal, as an example, the LPF unit 1320, the envelope detection unit 1321, the synchronization unit 1322, and the demodulation unit 1323 of FIG. 13, to enable each block to be used to receive these WU radio signals. Thereafter, at 1904, the controller 1319 performs a timeout determination of whether the WUR mode transition request packet has been received within a predetermined time. In a case of determining not a timeout, the process proceeds to 1905, and in a case of determining a timeout, the process proceeds to 1907. The controller 1319 receives the data packet using the WU radio signal at 1905, and determines whether the received data packet is the WUR mode transition request packet at 1906. In a case of the WUR mode transition request packet, the process proceeds to 1910, and in a case of not the WUR mode transition request packet, the process returns to 1904. At 1910, the controller 1319 transitions the station 1002 (1003) to the standby state (WUR mode) and terminates the flow. In order to perform the recovery procedure from 1907, the controller 1319 transmits a WUR recovery request packet to the access point 1001 by using a wireless LAN signal to determine if an acknowledgement response (ACK) packet for this WUR recovery request packet using the wireless LAN signal has been received at 1908. In a case that the reception is successful, the process returns to 1904, and in a case that the reception is failed, the process proceeds to 1909. The controller determines if the time configured to receive this acknowledgement response packet has elapsed to be timeout. In a case of not timeout, the process returns to 1908 again to receive the acknowledgement response packet, and in a case of determining timeout, the recovery process ends and the series of flows is terminated as an error. Although only one WUR recovery request packet has been transmitted in FIG. 17, the WUR recovery request packet may be transmitted again after the timeout determination and thus the WUR recovery request packet may be transmitted multiple times.

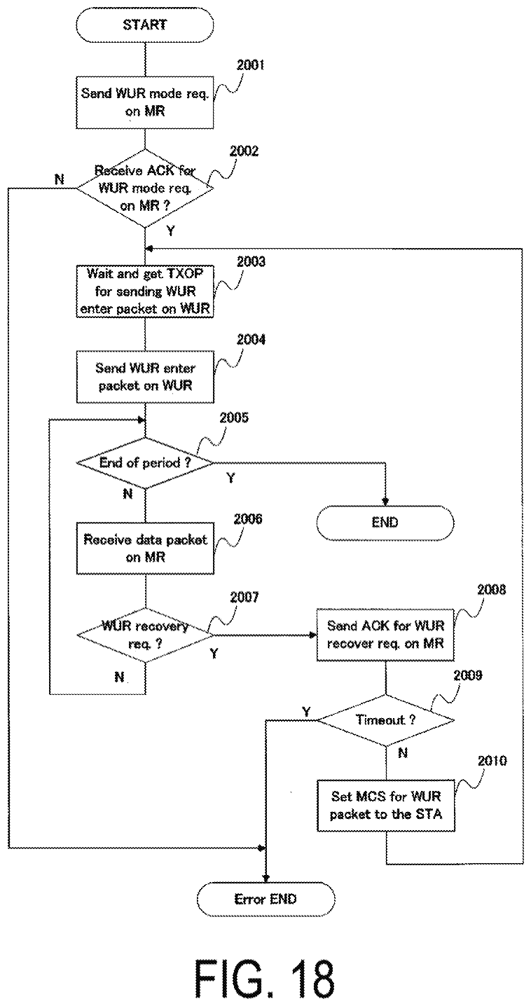

Next, a control flow of the controller 1219 of the access point 1001 to realize the message flow illustrated in FIG. 9 will be described with reference to FIG. 18. At 2001, the controller 1219 transmits a WUR mode transition request packet by using a wireless LAN signal to the station 1002 (1003). Then, at 2002, the controller determines if an acknowledgement response (ACK) packet for the WUR mode transition request packet transmitted at 2001 has been received. In a case that the reception is successful, the flow proceeds to 2003, and in a case that this acknowledgement response packet has not been received, the flow is terminated as an error. Returning to 2001 before termination as an error, the WUR mode transition request packet may be transmitted again. At 2003, the controller 1219 waits for a predetermined time, and performs carrier sense to ensure the transmission opportunity (TXOP) for transmitting the WUR transition packet with the WU radio signal. This latency may be configured to be longer than the latency prior to carrier sense in a case of using wireless LAN signals, taking into account the time it takes the station 1002 (1003) to receive the WU radio signal. After the transmission opportunity has been ensured, the process proceeds to 2004, and the controller 1219 transmits the WUR transition packet by utilizing the WU radio signal. Thereafter, the process proceeds to 2005, and the controller 1219 determines whether the period in which the station 1002 (1003) may use the recovery procedure has ended. In a case of determining this period has ended, the flow is terminated, and in a case of determining within this period, the process proceeds to 2006. At 2006, the controller 1219 receives a data packet utilizing the wireless LAN signal, and then determines at 2007 whether the data packet is a WUR recovery request packet. In a case of not the WUR recovery request packet, the process returns to 2005, and in a case of the WUR recovery request packet, the process proceeds to 2008. At 2008, the controller 1219 transmits an acknowledgement response packet for the received WUR recovery request packet by utilizing a wireless LAN signal and then the process proceeds to 2009. At 2009, the controller 1219 determines if reception of the WUR recovery request packet corresponding to the WUR mode transition request packet transmitted at 2001 reaches a predetermined number of times and the timeout condition has been satisfied. In a case of determining timeout, the flow is terminated as an error, and in a case of not determining timeout, the flow proceeds to 2010. At 2010, the modulation coding scheme (MCS) of WUR signals transmitted to the station 1002 (1003) that has transmitted the WUR mode transition request packet at 2001 is reconfigured, and the process returns to 2003. An MCS used during reconfiguration of the MCS may use a lower speed and lower error rate.

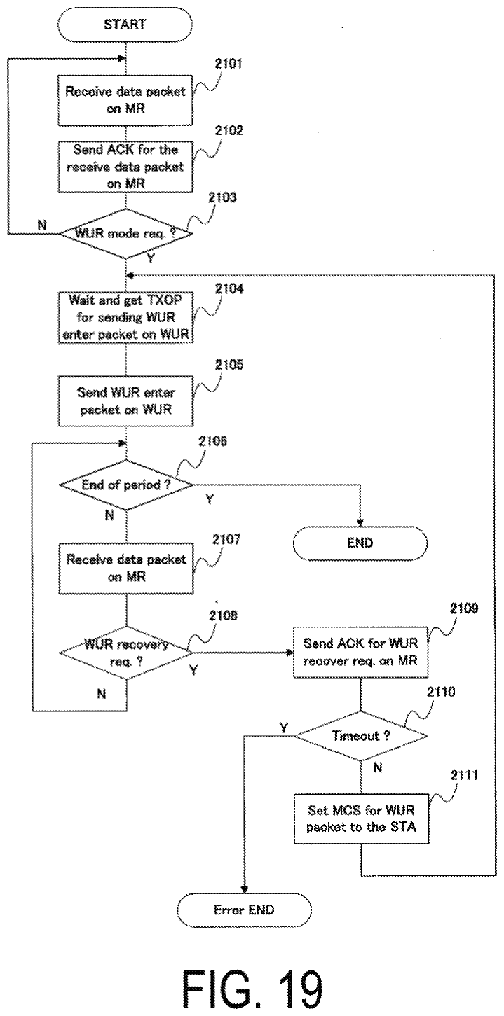

Next, a control flow of the controller 1219 of the access point 1001 to realize the message flow illustrated in FIG. 10 will be described with reference to FIG. 19. At 2101, the controller 1219 receives a data packet utilizing a wireless LAN signal, and then transmits an acknowledgement response packet for the received data packet at 2101 by utilizing a wireless LAN signal. Thereafter, at 2103, the controller 1219 determines if the data packet received at 2101 is a WUR mode transition request packet. In a case of not the WUR mode transition request packet, the process returns to 2101, and in a case of the WUR mode transition request packet, the process proceeds to 2104. At 2104, the controller 1219 waits for a predetermined time, and performs carrier sense to ensure the transmission opportunity (TXOP) for transmitting the WUR transition packet with the WU radio signal. This latency may be configured to be longer than the latency prior to carrier sense in a case of using wireless LAN signals, taking into account the time it takes the station 1002 (1003) to receive the WU radio signal. After the transmission opportunity has been ensured, the process proceeds to 2105, and the controller 1219 transmits the WUR transition packet by utilizing the WU radio signal. Thereafter, the process proceeds to 2106, and the controller 1219 determines whether the period in which the station 1002 (1003) may use the recovery procedure has ended. In a case of determining this period has ended, the flow is terminated, and in a case of determining within this period, the process proceeds to 2107. At 2107, the controller 1219 receives a data packet utilizing the wireless LAN signal, and then determines at 2108 whether the data packet is a WUR recovery request packet. In a case of not the WUR recovery request packet, the process returns to 2106, and in a case of the WUR recovery request packet, the process proceeds to 2109. At 2109, the controller 1219 transmits an acknowledgement response packet for the received WUR recovery request packet by utilizing a wireless LAN signal and then the process proceeds to 2110. At 2110, the controller 1219 determines if reception of the WUR recovery request packet corresponding to the WUR mode transition request packet received at 2101 reaches a predetermined number of times and the timeout condition has been satisfied. In a case of determining timeout, the flow is terminated as an error, and in a case of not determining timeout, the flow proceeds to 2111. At 2111, the modulation coding scheme (MCS) of WUR signals transmitted to the station 1002 (1003) that has received the WUR mode transition request packet at 2001 is reconfigured, and the process returns to 2104. An MCS used during reconfiguration of the MCS may use a lower speed and lower error rate.

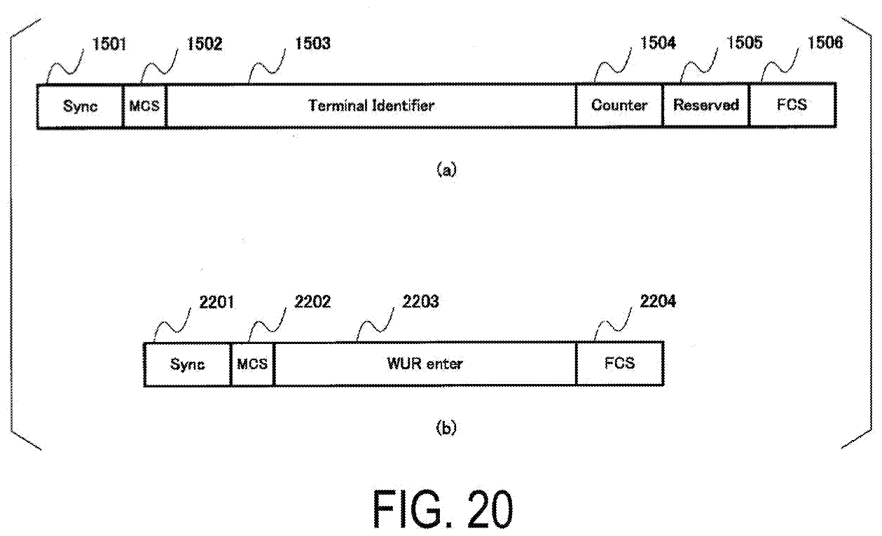

In the message flows of FIG. 9 and FIG. 10, a WUR mode transition packet that is transmitted by utilizing a WU radio signal may be able to check whether the WU radio signal transmitted by the access point 1001 can be received at the station 1002 (1003). Since the destination of the WUR mode transition packet need not be identified, a shorter radio frame may be used than a radio frame used in a normal WU radio packet. An example is illustrated in FIG. 20. FIG. 20(a) is a similar configuration to the WU radio frame illustrated in FIG. 15 and is provided with the same reference signs. FIG. 20(b) is an example of a structure of a radio frame of a WUR mode transition packet, which includes a synchronization part 2201, an MCS field 2202, a WUR mode transition field 2203, and an FCS field 2204. The station having received the WUR radio frame may detect a reception error of the WUR mode transition field 2203 by using the value of the FCS field 2204. The value included in the WUR mode transition field 2203 may be a value that can determine being transmitted from the access point 1001, and, for example, BSS color, a part of the MAC address of the access point 1001, a hash value of the MAC address, a value included in the WUR mode transition packet, and the like may be used. The length of the WUR mode transition field may be shorter than the payload of the WUR radio frame including the terminal identifier 1503, the counter field 1504, the reservation field 1505, and the like, and may be shorter than the terminal identifier field 1503.

Note that the MCS used in a case of transmitting the WU radio signal may be a pre-configured value by the access point 1001, or may be configured by a value included in the WUR mode transition request packet.

Note that the station 1002 (1003) with the function of transitioning to the WUR mode can temporarily stop (suspend) the WUR mode. The station 1002 (1003) may include information indicating that the WUR mode is temporarily stopped in the response frame transmitted to the access point 1001 at 1602. The station 1002 (1003) may include information indicating that the transition to the WUR mode is rejected in the response frame transmitted to the access point 1001 at 1602. In a case that the access point 1001 receives from the station 1002 (1003) a response frame that includes information indicating that the WUR mode is temporarily stopped or information that the transition to the WUR mode is rejected, the access point 1001 does not transmit the WUR frame to the station 1002 (1003). Note that the station 1002 (1003) not necessary includes information indicating that the WUR mode described above is temporarily stopped, for a response frame to the frame that includes information indicating the transition to the WUR mode transmitted from the access point 1001, and the frame may be transmitted actively from the station 1002 (1003) to the access point 1001.

Note that the access point 1001 can transmit frames transmitted at 1601 simultaneously to multiple stations. The access point 1001 may include information indicating a radio resource configured for a response frame transmitted by each station at 1602 in frames transmitted at 1601. The radio resource is a resource unit configured to divide a communication bandwidth configured by the access point 1001 into multiple bands. As such, the access point 1001 ensures the TXOP considering the response frame of 1602 in a case of transmitting the frame at 1601. In a case that the access point 1001 transmits frames to the multiple stations at 1601, the access point 1001 transitions to transmission of WUR frames of 1604 in a case that a response frame is received from at least one of the multiple stations at 1602. The access point 1001, at 1602, transitions to the recovery procedure described above in a case that no response frame is received from all of the multiple stations.

Note that in a case that the station 1002 (1003) is configured with the transition to the WUR mode and return to the wireless LAN mode before the transition procedure to the WUR mode described above is performed (for example, in a case that the station 1002 (1003) is configured with the transition to the WUR mode and return to the wireless LAN mode periodically and the period or the like is configured), the station 1002 (1003) may not transmit the response frame of 1602, and may include information indicating that the station 1002 (1003) is already configured with the transition to the WUR mode and return procedure to the wireless LAN mode in the response frame of 1602.

Operating as described above allows the station 1002 (1003) to confirm that the delivery of the WU radio signal is successful before transitioning to the standby state (WUR mode) and significantly reduce failure to receive the WU radio frame after transitioning to the standby state.

### Second Embodiment

In the first embodiment, transmit power control of the wireless LAN signal has not been performed, but transmit power of the wireless LAN signal in a case of transmitting the WUR mode transition request packet from the access point 1001, or transmit power of the wireless LAN signal in a case of transmitting the acknowledgement response packet for the WUR mode transition request packet may be controlled, so that the delivery distance becomes equivalent to the delivery distance of the WU radio signal. As a result, it is possible to estimate an approximate delivery distance of the WU radio signal at the time of transmission and reception of the WUR mode transition request packet, depending on whether the acknowledgement response packet can be received, and it possible to reduce the possibility of errors in the result of performing the message flow indicated in the first embodiment. As a result of the acknowledgement response of the WUR mode transition request packet to which the power control has been applied, the MCS of the WU radio signal included in the WUR mode transition request packet may be changed and the transmit power of the WUR mode transition request packet may be changed together.

For example, at 1602, the station 1002 (1003) may include information referred to in a case that the access point 1001 configures a transmit power of the WUR frames, in a response frame transmitted to the access point 1001. The station 1002 (1003) may include information indicating RSSI of the frame received at 1601 and information indicative of the received power (target received power, target RSSI) desired by the station 1002 (1003) in the response frame.

For example, at 1602, the station 1002 (1003) may include information referred to in a case that the access point 1001 configures the MCS configured for the WUR frames transmitted at 1604, in a response frame transmitted to the access point 1001. The station 1002 (1003) may include information indicative of a desired MCS or recommended MCS in the response frame.

Operating as described above allows the station 1002 (1003) to confirm that the delivery of the WU radio signal is successful before transitioning to the standby state (WUR mode) and significantly reduce failure to receive the WU radio frame after transitioning to the standby state.

### Third Embodiment

In a case of performing the flow illustrated in FIG. 9, FIG. 10, and FIG. 11, and that a station is spoofing a station that is transitioning to a standby state, and the spoofing station transmits a PS-poll packet by using a terminal identifier of a station transitioning to the standby state, data packets that should not otherwise be transmitted from the access point may be transmitted and the original destination station may fail to receive data packet. By performing signaling using the WUR mode transition request packet illustrated in FIG. 9 and FIG. 10, and only receiving a PS-poll packet transmitted from a station that has been determined to be transitioning to the standby mode, it possible to reduce the opportunity for such attacks to be established.

By operating as described above, it is possible to reduce the possibility that untransmitted data at the access point will be transmitted during the station transitioning to the standby state, and it possible to reduce communication failure across the standby state.

### Common to All Embodiments

A program running on an apparatus according to an aspect of the present invention may serve as a program that controls a Central Processing Unit (CPU) and the like to cause a computer to function in such a manner as to realize the functions of the embodiment according to the aspect of the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiment according to an aspect of the present invention may be recorded in a computer-readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining the program for a short time, or any other computer readable recording medium.

Furthermore, each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, one or more aspects of the present invention can use a new integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

One aspect of the present invention is available for radio communication apparatuses. An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1001 Access point
1002, 1003 Station
1501, 1701, 2201 Synchronization part
1502, 1702, 2202 MCS field
1503, 1703 Terminal identifier field
1504, 1704 Counter field
1505, 1705 Reservation field
1506, 1706, 2204 FCS field
2203 WUR mode transition field
1511 BSS color field
1512 Association identifier field
1513 Partial AID field
1401, 1801 Legacy part
1402, 1802-1 to 1802-6 WU radio part
1201, 1310 Preamble generation unit
1202, 1302 Transmission data control unit
1203, 1303 Mapping unit
1204, 1304 IDFT unit
1205, 1305 P/S conversion unit
1206, 1306 GI addition unit
1207, 1307 D/A conversion unit
1208, 1308 Transmission RF unit
1209, 1309 Antenna switching unit
1210, 1310 Antenna unit
1211, 1311 Reception RF unit
1212, 1312 A/D conversion unit
1213, 1313 Symbol synchronization unit
1214, 1314 S/P conversion unit
1215, 1315 DFT unit
1216, 1316 Demapping unit
1217, 1317 Received data control unit
1218 DS control unit
1219, 1319 Controller
1318 Application IF unit
1320 LPF unit
1321 Envelope detection unit
1322 Synchronization unit
1323 Demodulation unit

1. An access point apparatus for connecting and wirelessly communicating with multiple station apparatuses including a first station apparatus, the access point apparatus comprising:
a transmission RE unit configured to transmit a wireless LAN signal and a wake-up radio signal;
a reception RE unit configured to receive a carrier sense and the wireless LAN signal; and
a controller configured to control a transmission signal and a reception signal, wherein
the controller performs signaling for a WUR transition with the first station apparatus by using the wireless LAN signal,
performs the carrier sense by using the reception RE unit in a WUR transition state after the signaling, and
transmits the wake-up radio signal by using the transmission RF unit after the carrier sense to cause the first station apparatus to transition to a WU radio standby state that uses the wake-up radio signal.

2. The access point apparatus according to claim 1, wherein
the controller is configured to perform, after transmitting the wake-up radio signal,
reception of a wake-up radio recovery request packet using the wireless LAN signal by using the reception RF unit, and
retransmission of the wake-up radio signal after receiving he wake-up radio recovery request packet.

3. The access point apparatus according to claim 2, wherein the controller is configured to reconfigure an MCS of the wake-up radio during the retransmission.

4. The access point apparatus according to claim 1, wherein the wake-up radio signal transmitted in the WUR transition state is different from the wake-up radio signal used in a case that the first station apparatus is in the WU radio standby state.

5. The access point apparatus according to claim 4, wherein a length of a radio frame of the wake-up radio signal transmitted in the WUR transition state is shorter than a length of a radio frame of the wake-up radio signal used in a case that the first station apparatus is in the WU radio standby state.

6. A station apparatus for connecting and wirelessly communicating with an access point apparatus, the station apparatus comprising:
a transmission RF unit configured to transmit a wireless LAN signal;
a reception RF unit configured to receive a carrier sense, the wireless LAN signal, and a wake-up radio signal; and
a controller configured to control a transmission signal and a reception signal, wherein
the controller is configured to perform signaling for a WUR transition with the access point apparatus by using the wireless LAN signal,
receive the wake-up radio signal by using the reception RF unit in a WUR transition state after the signaling, and
cause the station apparatus to transition to a WU radio standby state that uses the wake-up radio signal after receiving the wake-up radio signal.

7. The station apparatus according to claim 6, wherein
in a case that the wake-up radio signal is not received within a prescribed time in the WUR transition state,
the controller transmits a wake-up radio recovery request packet that uses the wireless signal by using the transmission RF unit.

8. The station apparatus according to claim 7, wherein
after transmitting the wake-up radio recovery request packet and receiving an acknowledgement response to the wake-up radio recovery request packet that uses the wireless LAN signal,
the controller causes the station apparatus to transition to a WU radio standby state that uses the wake-up radio signal in a case that the wake-up radio signal is received by using the reception RF unit.

9. A communication method for an access point apparatus for connecting and wirelessly communicating with multiple station apparatuses including a first station apparatus, the communication method comprising the steps of:
transmitting a wireless LAN signal;
transmitting a wake-up radio signal;
performing a carrier sense; and
receiving the wireless LAN signal, wherein
signaling for a WUR transition is performed with the first station apparatus by using the wireless LAN signal,
the carrier sense is performed in a WUR transition state after the signaling, and
the wake-up radio signal is transmitted after the carrier sense to cause the first station apparatus to transition to a WU radio standby state that uses the wake-up radio.

10. A communication method for a station apparatus for connecting and wirelessly communicating with an access point apparatus, the communication method comprising the steps of:
transmitting a wireless LAN signal;
performing a carrier sense;
receiving the wireless LAN signal; and
receiving a wake-up radio signal, wherein
signaling for a WUR transition is performed with the access point apparatus by using the wireless LAN signal,
the wake-up radio signal is received in a WUR transition state after the signaling, and the station apparatus is caused to transition to a WU radio standby state that uses the wake-up radio signal after the wake-up radio signal is received.
